(19) United States
(12) Patent Application Publication
(10) Pub. No.: US 2026/0054167 A1
(43) Pub. Date: Feb. 26, 2026

(54) FULLY CONTROLLED CAMERA SYSTEMS IN INTERACTIVE GAMES

(71) Applicant: Skydance Silicon Valley, LLC, Santa Monica, CA (US)

(72) Inventors: Jeremy Luke Isaak, Canada (CA); Blake Stephen Guest, Santa Monica, CA (US); Julian Anthony Beak, Santa Monica, CA (US); Amy Jeanne Hennig, Santa Monica, CA (US)

(73) Assignee: Skydance Silicon Valley, LLC, Santa Monica, CA (US)

(21) Appl. No.: 19/300,586

(22) Filed: Aug. 14, 2025

Related U.S. Application Data
(60) Provisional application No. 63/686,333, filed on Aug. 23, 2024.

(51) Int. Cl. A63F 13/52; G06T 15/20

(52) U.S. Cl. CPC A63F 13/52; G06T 15/20

(57) ABSTRACT

Embodiments described herein teach of fully controlled camera systems for interactive game environments that automate camera perspective changes to create a cinematic experience without requiring manual player input. Within a given game environment, a plurality of potential camera points are established, each representing a possible view. When a cut point, which is a trigger based on gameplay, narrative events, or a technical evaluation, occurs, the system initiates a selection process. It generates a camera score for each available camera point. This score is a numerical value representing the quality and suitability of that perspective based on various data. The system then automatically cuts the rendered view to the camera point with the highest current camera score. This ensures the player is always presented with the most optimal and immersive viewpoint, enhancing storytelling and reducing the complexity of camera management.

### PRIORITY

This application claims the benefit of, and priority to U.S. Provisional Application, entitled “Fully Controlled Camera Systems in Interactive Games,” filed on Aug. 23, 2024 and having application Ser. No. 63/686,333, the entirety of each of said application being incorporated herein by reference.

### FIELD

The present disclosure relates to interactive games. More particularly, the present disclosure relates to utilizing a fully controlled camera system within an interactive game.

### BACKGROUND

In three-dimensional interactive games, the use of camera controls has been highly prevalent, as it allows players to navigate and interact with complex environments. Players typically use control sticks or mouse inputs to adjust the camera angle, ensuring they have a view of their surroundings and can respond to in-game challenges. However, in these traditional games where players control the game camera with, for example, a control stick, a common issue is that players spend significant amounts of time staring at the back of their main character. This setup often results in a detached experience, where the player feels like they are controlling a remote-controlled object rather than embodying the character they are playing. The constant rear view limits the sense of immersion, making it difficult for players to fully engage with the game world and the character's experiences.

Controlling a three-dimensional game camera can also present a steep learning curve, particularly for newer players who may struggle with the complexity of navigating and adjusting the camera. Unlike two-dimensional games where movement and perspective are straightforward, three-dimensional environments require players to manage an additional axis of control, often leading to disorientation and frustration. New players must learn to coordinate their character's movements with the camera's angle, ensuring they maintain a clear view of their surroundings while also responding to in-game challenges. This dual tasking can sometimes be overwhelming, as it involves mastering the use of control sticks or mouse inputs to achieve smooth and precise camera adjustments. Additionally, the sensitivity settings, inversion options, and various camera modes can add layers of complexity, making it difficult for inexperienced players to find a comfortable setup.

These challenges can detract from the enjoyment of the game, as players may spend more time wrestling with camera controls than engaging with the gameplay and story, potentially discouraging continued play and diminishing the overall gaming experience. These issues can create a psychological barrier for the player, reducing the emotional connection and sense of presence within the game. Instead of feeling like they are part of the action, players may feel more like observers, which can diminish the overall impact of storytelling and character development.

### SUMMARY OF THE DISCLOSURE

Systems and methods for utilizing a fully controlled camera system within an interactive game in accordance with embodiments of the disclosure are described herein.

In some embodiments, a device, includes a processor, a memory communicatively coupled to the processor, and a full control camera logic stored in the memory and executed by the processor. The logic is configured to establish an environment with a plurality of camera points, render a camera at one of the plurality of camera points, determine that a potential cut point has occurred, evaluate the plurality of camera points wherein each camera point is associated with a current camera score, and cut to the camera point with the highest current camera score.

In some embodiments, the plurality of camera points are associated with a video game environment.

In some embodiments, the video game environment is rendered in real-time or near real-time.

In some embodiments, the cut point occurs in response to entering a new area.

In some embodiments, the rendered camera has a camera score generated continuously.

In some embodiments, the cut point occurs when the rendered camera score falls below a predetermined threshold.

In some embodiments, the cut point occurs in response to a dialogue sequence initiating.

In some embodiments, the evaluation of the current camera score is based on at least historical data.

In some embodiments, the evaluation of the current camera score is based on at least player feedback.

In some embodiments, the full control camera logic is further configured to establish a buffer with a predetermined time after cutting to the camera point with the highest camera score.

In some embodiments, the full control camera logic is further configured to determine, in response to evaluating the plurality of camera points, if the predetermined time within the buffer has elapsed.

In some embodiments, cutting to the camera point with the highest current camera score occurs only if the predetermined time within the buffer has elapsed.

In some embodiments, a method of cutting a camera within a virtual environment includes establishing an environment with a plurality of camera points, rendering a camera at one of the plurality of camera points, determining that a potential cut point has occurred, evaluating the plurality of camera points wherein each camera point is associated with a current camera score, and cutting to the camera point with the highest current camera score.

In some embodiments, the virtual environment is a video game environment.

In some embodiments, the video game environment is rendered in real-time or near real-time.

In some embodiments, the evaluation of the plurality of camera points is done continuously.

In some embodiments, the potential cut point is associated with a predetermined threshold score.

In some embodiments, the cutting is done automatically in response to the current camera score associated with the rendered camera falls below the predetermined threshold score.

In some embodiments, a method of providing a current camera score includes receiving a request to generate a current camera score, gathering a base score, evaluate a plurality of data types, modify the camera score based on each of the plurality of data types, and transmit the modified camera score.

In some embodiments, the method further includes determining, prior to gathering a base score, if there is a previously generated camera score, evaluating, if there is a previously generated camera score, if a sufficient change has occurred to warrant the generation of a new camera score, generating, in response to determining that a sufficient change has not occurred, a delta value, modifying the previously generated camera score with the delta value, transmitting the modified previously generated camera score.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a video game ecosystem in accordance with various embodiments of the disclosure;

FIG. 2 is a conceptual block diagram of a device suitable for configuration with a full control camera logic, in accordance with various embodiments of the disclosure;

FIG. 3 is an abstract block diagram of the components of a fully controlled camera system 300 in accordance with various embodiments of the disclosure;

FIG. 4 is an abstract block diagram of the data within a storage of a fully controlled camera system in accordance with various embodiments of the disclosure;

FIG. 5 is a conceptual illustration of utilizing points of interest in a fully controlled camera system in accordance with various embodiments of the disclosure;

FIG. 6 is a conceptual illustration of utilizing character traits in a fully controlled camera system in accordance with various embodiments of the disclosure;

FIG. 7 is a conceptual illustration of virtual camera framing using cinematographic principles in accordance with various embodiments of the disclosure;

FIG. 8 is a conceptual illustration of a game environment with a plurality of available camera points in accordance with various embodiments of the disclosure;

FIG. 9 is a conceptual illustration of a virtual editor in a fully controlled camera system in accordance with various embodiments of the disclosure;

FIG. 10 is a flowchart of a process for evaluating preexisting camera scores in accordance with various embodiments of the disclosure;

FIG. 11 is a flowchart of a process for evaluating generated camera scores in accordance with various embodiments of the disclosure; and

FIG. 12 is a flowchart of a process for generating a camera score in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems outlined above, embodiments of the disclosure described herein can utilize an innovative fully controlled camera system in a game where the camera automatically switches between different angles during gameplay, unlike traditional games where players manually control the camera. This system can leverage various cinematographic principles to make these cuts occur and are perceived seamlessly, enhancing the cinematic quality of the game and maintaining immersion. In many embodiments, a goal is to create a gameplay experience that looks and feels like a movie, with dynamic camera angles and transitions that respond to the action in real-time.

In traditional games a single orbiting camera is often used that players can control, but embodiments described herein can integrate various heuristics and other processes to manage camera angles automatically, adhering to rules of cinema such as the 180-degree rule, avoiding jump cuts, and framing shots effectively. This approach can allow the game to maintain a cinematic feel even during intense combat scenes, making the gameplay look like a polished action movie.

The fully controlled camera system can be configured to keep players oriented and engaged by using screen-relative controls, meaning the direction the player moves is always consistent with what they see on screen, regardless of camera angle changes. This can reduce the learning curve and disorientation for players, allowing them to focus on the action rather than camera management. In many embodiments, an aim is to perfect the fully controlled camera system to the point where manual camera control is unnecessary, providing a seamless and intuitive experience that aligns with narrative and gameplay needs.

Various embodiments described herein can facilitate these automatic camera cuts by scoring a plurality of cameras associated with various camera points in different gaming environments. For example, as the player moves throughout the game world, they encounter different environments, levels, or other areas. Each of these locations can be configured with various camera points that may be static in the scene or dynamically located such as over-the-shoulder shots. Each camera that may be selected to cut to in a game scene can have a score associated with it. These scores can be utilized to compare and select which camera should be next when a cut point event is encountered. As described in more detail below, each camera point can have a variety of data associated with it that can color the way the score is weighted and/or otherwise evaluated. As camera scores cross a given threshold, the fully controlled camera system can initiate a cut to that camera within the scene.

In various embodiments, the full control camera logic may be configured to utilize one or more predetermined thresholds or timers to control the triggering of subsequent actions. A predetermined threshold may be a numerical value, a score, or a state, which is compared against a current value from the game environment. Depending on the configuration, a subsequent action may be triggered only when the current value is determined to have exceeded the predetermined threshold. In other configurations, an action may be triggered if the current value has not yet exceeded the threshold. This allows for flexible control logic where actions can be initiated based on both achieving a condition and the continued existence of a state that has not yet met the condition. Similarly, a predetermined timer may be established to measure a duration of time. The system may be configured to determine if the predetermined timer has elapsed. In response to determining that the timer has elapsed, a subsequent action may be initiated. This use of configurable thresholds and timers provides a flexible mechanism for controlling system behavior in response to dynamic conditions.

The term “camera,” as used herein, can refer to the virtual viewpoint from which a three-dimensional game environment may be rendered and presented to a player. Unlike a physical camera, a camera in a video game environment may be a logical construct, an observer within the virtual space that can be defined by a set of parameters such as position, orientation (pitch, yaw, roll), field of view, and aspect ratio. It can be the movable window through which a player may perceive and interact with the game world.

In the context of the present disclosure, a camera can be the entity that is rendered at one of the plurality of camera points. While a camera point may define a potential perspective, the camera may be the active component that generates the visual output from that perspective. The full control camera logic can manage the active camera, and a “cut” may be effectuated by transitioning this active camera from its current camera point to a new, higher-scoring camera point, which can thereby change the player's view of the scene.

The term “camera point,” as used herein, can refer to a data structure representing a potential camera perspective within a game environment. A camera point may be static, having a fixed position and orientation that may be defined by a game designer, or it may be dynamic, having a position and orientation that can be calculated in real-time relative to a character or object within the game environment. Each camera point may be associated with a plurality of parameters that can define its behavior, which may include, but are not limited to, position, orientation, field of view, and virtual lens characteristics.

Within the context of the full control camera system, a plurality of camera points can be established within an environment to provide a rich palette of potential shots. These camera points may serve as the discrete options from which the system can choose to render the scene. For example, an environment may include fixed camera points for cinematic establishing shots and dynamic, over-the-shoulder camera points that can follow the player character, each of which may offer a different perspective on the action.

The term “cut point,” as used herein, can refer to a specific event, trigger, or condition within the game environment that may initiate an evaluation process to determine if a change in the rendered camera perspective should occur. A cut point may serve as the impetus for the system to assess the current visual presentation and decide whether a new camera point should be selected to improve the player's experience.

A cut point may be triggered by various occurrences. In some embodiments, a cut point may be triggered by a gameplay event, such as a player entering a new area or a view of the player character becoming obstructed. In other embodiments, a cut point may be triggered by a narrative event, such as the initiation of a dialogue sequence. In further embodiments, a cut point may be determined by a technical evaluation, such as the score of the currently rendered camera falling below a predetermined threshold.

The term “camera score,” as used herein, can refer to a numerical value that may be generated by the full control camera logic to represent the quality, suitability, or cinematic appropriateness of a particular camera point at a given moment in time. The camera score can be a quantitative metric that may be calculated based on a plurality of data types, which can include, but are not limited to, environmental data, player data, and cinematic data.

A primary function of the camera score may be to enable an objective comparison between the currently rendered camera point and other available camera points. During an evaluation that may be triggered by a cut point, the system can generate or retrieve a camera score for each of the plurality of camera points. The system may then compare these scores to identify the camera point with the highest current camera score, which may be deemed the most suitable perspective for the subsequent shot.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

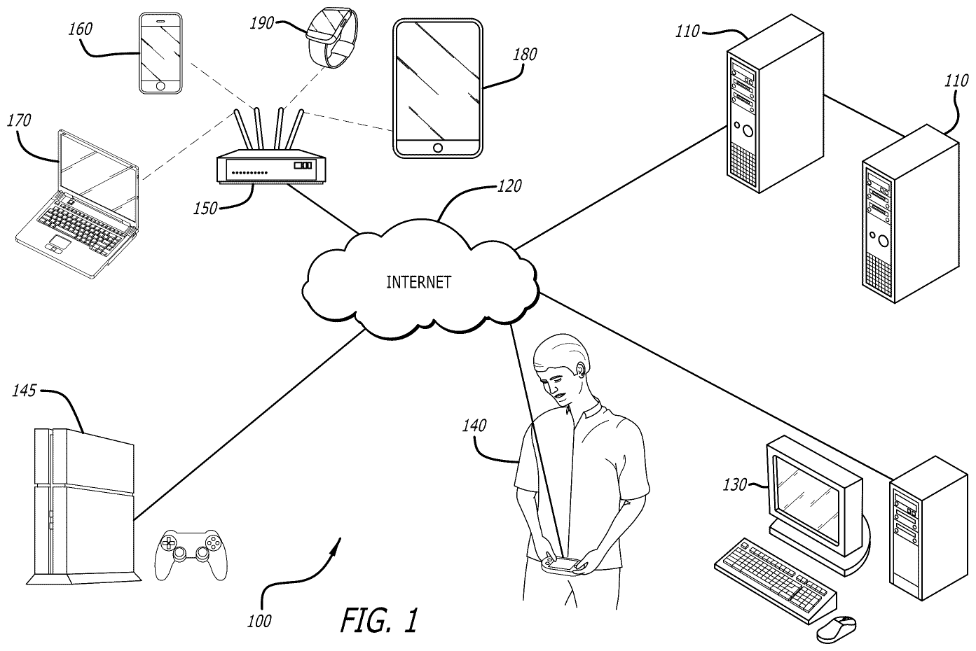

Referring to FIG. 1, a video game ecosystem 100 in accordance with various embodiments of the disclosure is shown. In many embodiments, the game can be designed to seamlessly integrate and function across various devices, including servers 110, home gaming consoles 145, mobile gaming consoles 140, laptops 170, personal computers 130, tablets 180, smartphones 160, wearable devices 190, and more. This integration can ensure a consistent and optimized gaming experience, regardless of the device being used.

In some embodiments, the game can be developed using a modular architecture, enabling compatibility and scalability across multiple platforms. The core game logic, assets, and the camera system may be abstracted into platform-agnostic modules. These modules can be encapsulated in a game engine designed to handle platform-specific requirements dynamically. As those skilled in the art will recognize, certain embodiments, such as games that require a client/server relationship may require one or more aspects of the game to be processed server-side in one or more of the servers 110.

In a number of embodiments, distribution of the game across the various platforms may leverage cloud-based infrastructure, enabling seamless delivery of game content to end-users. Upon release, the game can be hosted on central servers 110 equipped with, or working in conjunction with, content delivery networks (CDNs) to minimize latency and ensure quick access. Players may download the game client tailored to their specific device. For home gaming consoles and personal computers, distribution can be through established digital storefronts, such as the Play Station Network, Xbox Live, Steam, and others. Mobile and tablet versions may be available via app stores like Google Play and Apple's App Store. Additionally, wearable devices and newer platforms can access the game through dedicated portals or companion apps.

In various embodiments, upon installation, the game may communicate with central servers 110 to authenticate users, sync progress, and manage in-game assets. In some embodiments, for instance, on higher-performance home gaming consoles 145 and PCs 130, the game may provide high-resolution, dynamic range views with advanced effects like depth of field and motion blur. On mobile devices and tablets, the camera system can optimize for performance, ensuring smooth gameplay while maintaining visual fidelity.

Certain embodiments of the ecosystem 100 may allow for cross-platform play, allowing users to interact and play together regardless of the device they are using. This architecture can support this by maintaining a unified player database and real-time synchronization of game states. In various embodiments, the camera system can adjust its parameters, scores, or views based on the device in use or the current state of other players within the online game, ensuring a consistent gameplay experience.

In more embodiments, updates can be distributed through the same channels as the original game, ensuring that all devices receive the latest features, bug fixes, and improvements simultaneously. The fully controlled camera system and any associated logic, being a part of the gameplay experience, may also receive regular updates and telemetry data to enhance functionality and performance based on user feedback and advancements in technology.

In additional embodiments, the ecosystem 100 can include one or more servers 110 that can play a role in ensuring smooth operation, synchronization, and management of the game across various devices. The server 110 can be configured to handle various operations such as, but not limited to, user authentication, ensuring that only legitimate users can access the game. This process may involve verifying login credentials and managing user sessions. Additionally, the server 110 can manage authorization, determining what resources and features each user is permitted to access based on their account type and progress within the game.

In further embodiments, the server 110 can maintain the game's overall state, ensuring consistency and synchronization across all connected devices. This may involve tracking player progress, in-game events, and real-time interactions. For multiplayer scenarios, the server 110 can ensure that all players experience the same game state, coordinating actions and updates to maintain a seamless multiplayer experience.

In still more embodiments, servers 110 can be responsible for delivering game content, including initial game files, updates, patches, and downloadable content (DLC). They may utilize content delivery networks (CDNs) to distribute these files efficiently, reducing latency and ensuring that players can quickly access and download necessary game data. In multiplayer games, the server 110 can manage matchmaking, pairing players based on their skill levels, preferences, and other criteria. Once matched, the server 110 may establish and manage game sessions, ensuring that players are connected to the appropriate game instances and maintaining the integrity of these sessions.

The server 110 may also be configured to store and manages all necessary game data, including user profiles, game progress, leaderboards, and in-game statistics. This data can be stored in secure databases and accessed and updated as needed to reflect players'actions and achievements within the game. To maintain a fair gaming environment, various embodiments of the server 110 can implement security measures and anti-cheat systems. These measures can be configured to detect and prevent unauthorized modifications, hacks, or exploits that could disrupt the game's balance or give certain players unfair advantages.

Servers 110 can also collect and analyze data related to game performance, user behavior, and system health. This information may be used to monitor the game's performance, identify and address issues, and inform future updates and improvements. Analytics can also help in understanding player engagement and preferences, guiding the development of new features and content. In yet additional embodiments, the server 110 can facilitate social features, such as friend lists, messaging, and in-game communities. It can sometimes manage interactions between players, supports communication channels, and ensures that social features are integrated seamlessly into the gaming experience. To handle varying numbers of concurrent players, the server 110 can be designed to have a scalable infrastructure. This may include utilizing load balancing techniques to distribute the workload evenly across multiple servers, ensuring consistent performance and preventing any single server from becoming a bottleneck.

In many embodiments, the ecosystem 100 may utilize the internet 120 and wireless network devices like routers 150 to efficiently deliver data across various devices, ensuring seamless connectivity and gameplay. For wireless devices, such as mobile gaming consoles 140, tablets 180, and wearable devices 190, the router 150 can provide Wi-Fi connectivity. Modern routers support high-speed wireless standards like Wi-Fi 6, which offer faster data rates, lower latency, and improved handling of multiple devices simultaneously. This can ensure a stable and efficient connection for gaming, even in households with numerous connected devices.

As the game operates, data packets are transmitted between the player's device and the servers 110. These packets may include user inputs, game state updates, and synchronization data. The router 150 can handle the routing of these packets, directing them to their destination through the internet. Advanced Quality of Service (QoS) settings on routers can prioritize gaming traffic to ensure minimal latency and reduced lag, enhancing the gaming experience. During multiplayer sessions, the router 150 can play a role in maintaining a stable connection. It manages data traffic between multiple players, ensuring that game state updates and player interactions are synchronized in real-time. The ecosystem 100 can also be configured to utilize peer-to-peer (P2P) networking in conjunction with traditional client-server models. In P2P setups, game data may be shared directly between players'devices, reducing the load on central servers and improving data transfer speeds. The router 150 can, in certain embodiments, facilitate these direct connections, ensuring that data packets are correctly routed between peers.

In a number of embodiments, a PC 130 can download the game/game client from a digital storefront from one or more servers 110. Once installed, the game client can connect to the game's servers 110 via the internet 120, authenticating the user and syncing their game data. In certain embodiments, the PC 130 can also interact with other devices in the ecosystem 100. For example, a player might use a mobile app on their tablet 180 or smartphone 160 to manage their game inventory or chat with friends while playing on their PC 130. These interactions can be facilitated by one or more servers 110, which can synchronize data across all connected devices, ensuring a unified and cohesive gaming experience.

As those skilled in the art will recognize, home gaming consoles 145 are often specifically designed for gaming, providing a consistent and optimized experience without the need for extensive configuration. In various embodiments, home gaming consoles 145 frequently include social and community features that are tightly integrated into the ecosystem 100. Players can easily add friends, join parties, and communicate through voice or text chat. Additionally, game content distribution on home gaming consoles 145 often involves digital storefronts. In additional embodiments, consoles are designed to work seamlessly with various peripherals and accessories, such as controllers, headsets, and virtual reality (VR) devices.

In further embodiments, a mobile gaming console 140 has a design emphasizing portability, featuring a compact form factor, built-in display, and rechargeable battery. This allows players to continue their gaming sessions seamlessly when moving between different locations. In various embodiments, the game client and associated game logic on the mobile gaming console is optimized to handle the specific hardware and connectivity characteristics of these devices, ensuring smooth performance and efficient battery usage.

The mobile gaming console 140 can also connect to other devices through companion apps or cloud gaming services. For example, a player might use a mobile app on their console 140 to manage in-game items or communicate with friends, synchronizing this data with their main game profile on the servers 110. In certain embodiments, cloud gaming services can allow the mobile gaming console 140 to stream games from powerful servers 110, bypassing the need for high-end local hardware and ensuring access to graphically intensive games that would otherwise be beyond the device's capabilities.

Furthermore, mobile gaming consoles 140 can often support local multiplayer gaming through ad-hoc networks or Bluetooth connections. This may allow players to connect directly with other nearby mobile gaming consoles 140 for shared gaming experiences without relying solely on the internet. The servers 110 can then sync any local multiplayer progress with the broader ecosystem 100 once the devices reconnect to the internet 120.

Unlike stationary PCs 130, laptops 170, can be used in various environments, from home to public spaces. Many gaming laptops 170 come with dedicated GPUs, allowing for high-quality graphics and smooth gameplay. Laptops 170 may also support various peripheral connections, including external displays, gaming controllers, and VR headsets, expanding their gaming capabilities.

In more embodiments, smartphones 160 can offer unique features like GPS, accelerometers, gyroscopes, and cameras, which can be integrated into gameplay to provide augmented reality (AR) experiences and location-based gaming. Touchscreens are often standard on smartphones 160, facilitating intuitive controls and gestures. The ubiquity of smartphones 160 can ensure that players can engage with the game ecosystem wherever they are, and mobile-specific features like notifications keep players connected to in-game events and updates. Additionally, smartphones 160 may often include biometric security features such as fingerprint scanners and facial recognition, enhancing secure access to game accounts and in-game purchases.

In numerous embodiments, wearable devices 190, such as, but not limited to, smartwatches and AR glasses, can add a layer of interaction that extends beyond traditional gaming platforms. These devices can provide real-time notifications, health tracking, and context-sensitive interactions based on the player's environment. For example, a smartwatch might track physical activity during a fitness game, providing feedback and integrating physical activity into the gaming experience. In another example, AR glasses can overlay game elements onto the real world, creating immersive and interactive experiences that blend reality with the virtual game environment. Wearable devices 190 may also enable continuous engagement with the ecosystem 100 through haptic feedback and voice commands, allowing players to interact without needing to look at a screen.

In still more embodiments, tablets 180 can offer a larger screen size than smartphones while maintaining portability, making them ideal for immersive gameplay on the go. Tablets 180 may be configured to support both touch and stylus input, providing precise control options for games that require fine-tuned interactions. They may also be excellent for split-screen or multi-window functionality, enabling players to run multiple apps simultaneously, such as a game and a companion app. Tablets 180 can easily connect to external peripherals like keyboards and game controllers, bridging the gap between mobile and traditional gaming setups.

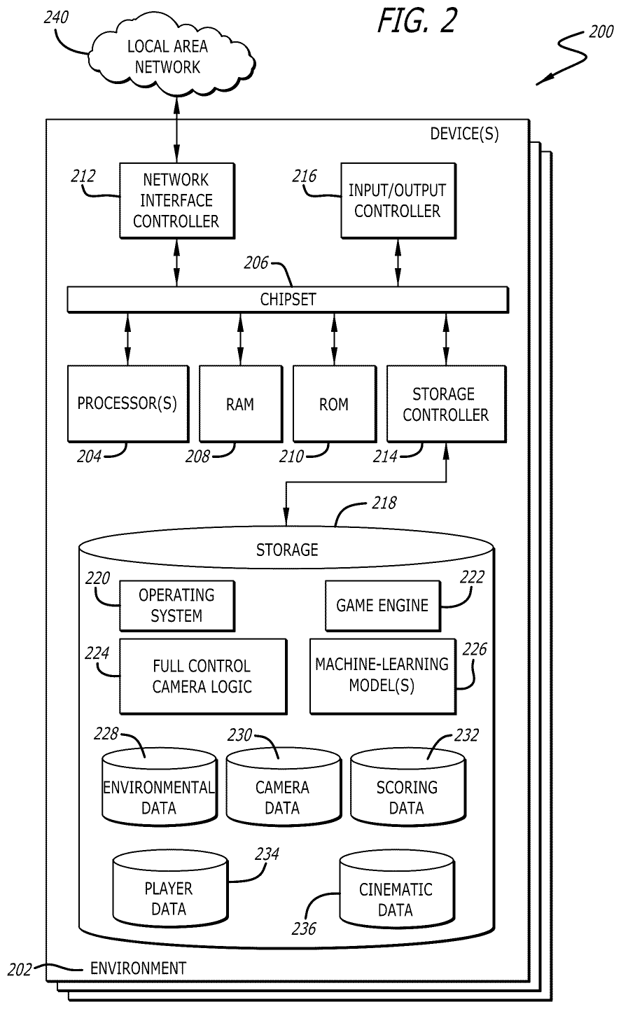

Although a specific embodiment for a video game ecosystem 100 is described above with respect to FIG. 1, any of a variety of systems and/or processes may be utilized in accordance with embodiments of the disclosure. For example, the video game ecosystem 100 may be configured into any number of various network topologies including different types of interconnected devices and user devices. The elements depicted in FIG. 1 may also be interchangeable with other elements of FIGS. 2-12 as required to realize a particularly desired embodiment.

Referring to FIG. 2, a conceptual block diagram of a device 200 suitable for configuration with a full control camera logic 224, in accordance with various embodiments of the disclosure is shown. The embodiment of the conceptual block diagram depicted in FIG. 2 can illustrate a conventional game device, personal computer, mobile game device, game server, laptop, tablet, network appliance, e-reader, smartphone, wearable device, or other computing device, and can be utilized to execute any of the application and/or logic components presented herein. The device 200 may, in many non-limiting examples, correspond to physical devices or to virtual resources described herein.

In many embodiments, the device 200 may include an environment 202 such as a baseboard or “motherboard,” in physical embodiments that can be configured as a printed circuit board with a multitude of components or devices connected by way of a system bus or other electrical communication paths. Conceptually, in virtualized embodiments, the environment 202 may be a virtual environment that encompasses and executes the remaining components and resources of the device 200. In more embodiments, one or more processors 204, such as, but not limited to, central processing units (“CPUs”) can be configured to operate in conjunction with a chipset 206. The processor(s) 204 can be standard programmable CPUs that perform arithmetic and logical operations necessary for the operation of the device 200.

In a number of embodiments, the processor(s) 204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 206 may provide an interface between the processor(s) 204 and the remainder of the components and devices within the environment 202. The device 200 can incorporate different types of processors to enhance performance and efficiency across various tasks. A central processing unit (CPU) can handle primary processing tasks such as game logic, AI, and player inputs, while a graphics processing unit (GPU) can be specialized for rendering high-resolution graphics and visual effects. Digital signal processors (DSPs) may manage audio processing, delivering high-quality sound without burdening the CPU. In portable devices, systems on a chip (SoCs) can be configured to integrate the CPU, GPU, memory, and peripherals to balance performance and efficiency. In some embodiments, application-specific integrated circuits (ASICs) can optimize specific functions like cryptographic processing, while neural processing units (NPUs) accelerate AI and machine learning tasks. Some high-end devices may also include physics processing units (PPUs) to handle complex physics calculations, further enhancing the realism and responsiveness of the gaming experience. However, those skilled in the art will recognize that the device 200 can any variety or combination of processor(s) 204 as needed to satisfy the desired application.

The chipset 206 can provide an interface to a random-access memory (“RAM”) 208, which can be used as the main memory in the device 200 in some embodiments. The chipset 206 can further be configured to provide an interface to a computer-readable storage medium such as a read-only memory (“ROM”) 210 or non-volatile RAM (“NVRAM”) for storing basic routines that can help with various tasks such as, but not limited to, starting up the device 200 and/or transferring information between the various components and devices. The ROM 210 or NVRAM can also store other application components necessary for the operation of the device 200 in accordance with various embodiments described herein.

Additional embodiments of the device 200 can be configured to operate in a networked environment using logical connections to remote computing devices and computer systems through a network, such as the local area network 240. The chipset 206 can include functionality for providing network connectivity through a network interface controller (“NIC”) 212, which may comprise a gigabit Ethernet adapter or similar component. The NIC 212 can be capable of connecting the device 200 to other devices over the local area network 240. It is contemplated that multiple NICs 212 may be present in the device 200, connecting the device to other types of networks and remote systems, such as the Internet.

In further embodiments, the device 200 can be connected to a storage 218 that provides non-volatile storage for data accessible by the device 200. The storage 218 can, for instance, store an operating system 220, and/or game engine 222. In various embodiments, the storage 218 can be connected to the environment 202 through a storage controller 214 connected to the chipset 206. In certain embodiments, the storage 218 can consist of one or more physical storage units. The storage controller 214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

In additional embodiments, the device 200 can store data within the storage 218 by transforming the physical state of the physical storage units to reflect the information being stored. The specific transformation of physical state can depend on various factors. Examples of such factors can include, but are not limited to, the technology used to implement the physical storage units, whether the storage 218 is characterized as primary or secondary storage, and the like.

In many more embodiments, the device 200 can store information within the storage 218 by issuing instructions through the storage controller 214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. In some embodiments, the device 200 can further read or access information from the storage 218 by detecting the physical states or characteristics of one or more particular locations within the physical storage units.

In addition to the storage 218 described above, certain embodiments of the device 200 may also have access to other computer-readable storage media to store and retrieve information, such as program modules, data structures, or other data. It should be appreciated by those skilled in the art that computer-readable storage media is any available media that provides for the non-transitory storage of data and that can be accessed by the device 200. In some examples, operations performed by a cloud computing network, and or any components included therein, may be supported by one or more devices similar to device 200. Stated otherwise, some or all of the operations performed by the cloud computing network, and or any components included therein, may be performed by one or more devices 200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 218 can store an operating system 220 utilized to control the operation of the device 200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 218 can store other system or application programs and data utilized by the device 200.

In many additional embodiments, the storage 218 or other computer-readable storage media is encoded with computer-executable instructions which, when loaded into the device 200, may transform it from a general-purpose computing system into a special-purpose computer capable of implementing the embodiments described herein. These computer-executable instructions may be stored as application and transform the device 200 by specifying how the processor(s) 204 can transition between states, as described above. In some embodiments, the device 200 has access to computer-readable storage media storing computer-executable instructions which, when executed by the device 200, perform the various processes described above with regard to FIGS. 1 and 3-12. In certain embodiments, the device 200 can also include computer-readable storage media having instructions stored thereupon for performing any of the other computer-implemented operations described herein.

In a number of embodiments, the device 200 can store a game engine 222 in storage 218 and load it when the game is launched, enabling quick access and execution. The game engine 222 can manage core tasks such as rendering graphics, processing inputs, handling physics calculations, and managing audio by leveraging the device's CPU, GPU, and other hardware components. It can abstract hardware complexities to ensure smooth gameplay and real-time interaction. Additionally, in various embodiments, the game engine 222 cam facilitate network communications for multiplayer interactions and supports cross-platform functionality, allowing games to run efficiently on various devices within the available game ecosystem.

In many further embodiments, the device 200 may include a full control camera logic 224. The full control camera logic 224 can be configured to perform one or more of the various steps, processes, operations, and/or other methods that are described above. Often, the full control camera logic 224 can be a set of instructions stored within a non-volatile memory that, when executed by the processor(s)/controller(s) 204 can carry out these steps, etc. In some embodiments, the full control camera logic 224 may be a client application that resides on a network-connected device, such as, but not limited to, a server, switch, personal or mobile computing device in a single or distributed arrangement.

In some embodiments, environmental data 228 can comprise various sub-data types point of interest data, environmental dimension data, play area data, and/or camera location data. In various embodiments, point of interest data can be utilized to highlight key objects or characters that the camera should focus on, ensuring that important elements are always in view. Environmental dimension data may provide the spatial parameters of the game environment that is being evaluated and/or rendered, allowing the camera to navigate and position itself accurately within that three-dimensional space. Play area data can be configured to define the boundaries and active regions where the player can move and/or gameplay can occur, helping the camera maintain optimal angles. Camera location data may include information about the current and potential positions of the camera, enabling dynamic adjustments to provide the best perspectives and avoid obstacles.

In more embodiments, camera data 230 may be utilized by a fully controlled camera system to facilitate the automatic management of camera movements for enhancement of the player's experience without requiring manual input. In some embodiments, the camera data 230 may comprise lens data for capturing information about focal length, aperture, depth of field, and the like, suitable for simulating real-world camera effects. Movement data can track and capture the camera's position and motion through the game environment. Base score data can include a base line score that each camera starts from when calculating a score for virtual editing. Framing data can ensures that key elements and characters are appropriately centered and visible within the frame. Camera type data may be configured to define the specific camera model or style being simulated, such as a handheld, Steadicam, cinematic, camcorder, drone camera, etc. Cameraman data can simulate or describe any human-operated camera movements, noise, or attributes to simulate a human camera operator, adding a layer of realism by mimicking how a person would handle the camera. Finally, camera weight data can account for the physical characteristics of the camera, influencing its inertia and how it responds to movements, contributing to a more authentic visual experience.

In further embodiments, scoring data 232 can include various sub-types of data including, but not limited to framing score data, player preference data, and update data. Framing score data can include various weights and items that can be utilized when generating a score for an associated camera point within a game environment. In some embodiments, player preference data can include data associated with one or more known player preferences, which can be captured from previous or historical gameplay, or “hints” provided to the game system, such as controller interactions. Finally, update data may provide one or more modifications to the weights utilized in one or more cameras or camera points when generating a score. For example, a certain camera within a game environment may never be selected due to the initial configuration of weights. Update data may allow for the modification of those weights such that the camera becomes a viable option for automatic cutting.

In various embodiments, player data 234 can comprise player type data as player movement data, among others. Player type data can be configured to describe one or more attributes related to the player and their current avatar or move set. For example, a player may have either a short-range attack or a long-range attack, which can be captured within the player type data. Similarly, play movement data may allow for the capture of characteristics to how the player may be able to move within a given game environment (running, walking, jumping abilities, etc.).

In still more embodiments, cinematic data 236 can include various heuristic data and telemetry data. As described in more detail below, heuristic data can include one or more heuristics associated with various cinematography or photography practices. In some embodiments, the heuristic data can be manually fine-tuned for a specifically desired game experience. However, as games are released and played by various players, telemetry data may be generated that gathers and otherwise transmits data related to various playthroughs done by players. In this way, the telemetry data can be used to update the game as desired by the game designers. For example, the telemetry data may indicate that players largely miss finding a particular hidden item in a gaming environment because a certain camera point is never selected. Utilizing this telemetry data, updates to the weights of the cameras within that gaming environment can be deployed such that more players may find that hidden item in the game.

In still further embodiments, the device 200 can also include one or more input/output controllers 216 for receiving and processing input from a number of input devices, such as a keyboard, a mouse, a touchpad, a touch screen, an electronic stylus, or other type of input device. Similarly, an input/output controller 216 can be configured to provide output to a display, such as a computer monitor, a flat panel display, a digital projector, a printer, or other type of output device. Those skilled in the art will recognize that the device 200 might not include all of the components shown in FIG. 2 and can include other components that are not explicitly shown in FIG. 2 or might utilize an architecture completely different than that shown in FIG. 2.

As described above, the device 200 may support a virtualization layer, such as one or more virtual resources executing on the device 200. In some examples, the virtualization layer may be supported by a hypervisor that provides one or more virtual machines running on the device 200 to perform functions described herein. The virtualization layer may generally support a virtual resource that performs at least a portion of the techniques described herein.

Finally, in numerous additional embodiments, data may be processed into a format usable by one or more machine-learning models 226 (e.g., feature vectors), and or other pre-processing techniques. The machine-learning (“ML”) models 226 may be any type of ML model, such as supervised models, reinforcement models, and/or unsupervised models. The ML models 226 may include one or more of linear regression models, logistic regression models, decision trees, Naïve Bayes models, neural networks, k-means cluster models, random forest models, and/or other types of ML models 226.

The ML model(s) 226 can be configured to generate inferences to make predictions or draw conclusions from data. An inference can be considered the output of a process of applying a model to new data. This can occur by learning from at least the environmental data 228, the camera data 230, the scoring data 232, player data 234, and/or the cinematic data 236. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a set of coordinates within a three-dimensional space, a probability distribution, a set of labels/characteristics/parameters, a decision about an action to take, etc. Ground truth for the ML model(s) 226 may be generated by human/administrator verifications or may compare predicted outcomes with actual outcomes.

Although a specific embodiment for a device suitable for configuration with the full control camera logic suitable for carrying out the various steps, processes, methods, and operations described herein is discussed with respect to FIG. 2, any of a variety of systems and/or processes may be utilized in accordance with embodiments of the disclosure. For example, the device 200 may be in a virtual environment such as a cloud-based game administration environment, or it may be distributed across a variety of network devices or servers. The elements depicted in FIG. 2 may also be interchangeable with other elements of FIGS. 1 and 3-12 as required to realize a particularly desired embodiment.

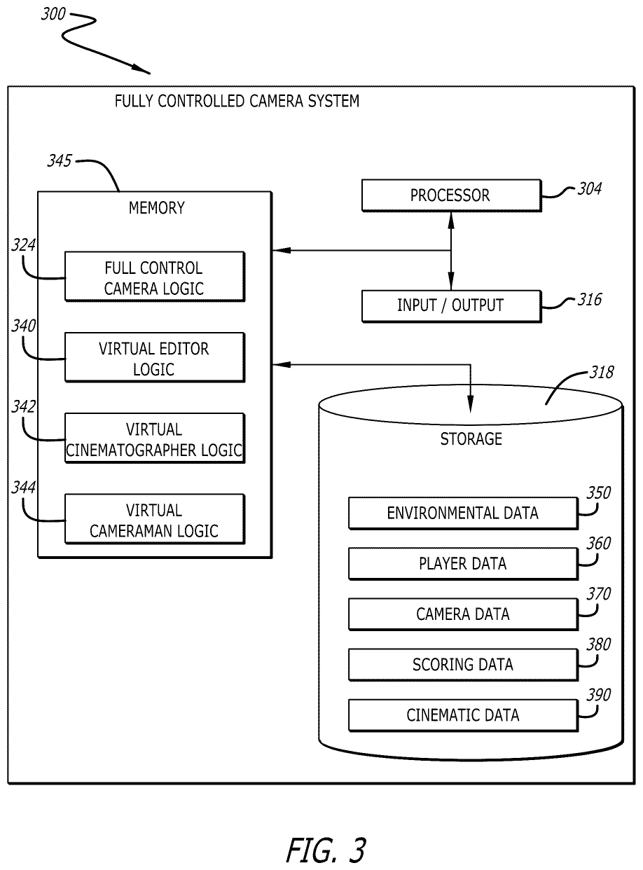

Referring to FIG. 3, an abstract block diagram of the components of a fully controlled camera system 300 in accordance with various embodiments of the disclosure is shown. In many embodiments, the fully controlled camera system 300 can be configured to include at least one or more processors 304, input/output functionality 316, a storage 318 as well as a memory 345 configured for executing one or more various logics. Specifically in the embodiment depicted in FIG. 3, the memory 345 comprises a full control camera logic 324 as well as a virtual editor logic 340, virtual cinematographer logic 342, and a virtual cameraman logic 344. Similarly, the storage 318 may comprise environmental data 350, player data 360, camera data 370, scoring data 380, and cinematic data 390.

In some embodiments, the full control camera logic 324 can facilitate the use of a camera system within a video game that is fully controlled by the system without input from the player. In certain embodiments, the full control camera logic 324 can work in conjunction with various other logics, such as a virtual editor logic 340, virtual cinematographer logic 342 and virtual cameraman logic 344. These logics may be configured as separate logics or may be interconnected or packaged/executed as a single logic.

In many embodiments, a virtual editor logic 340 in a fully controlled camera system 300 may consist of heuristics and rules designed to automatically adjust camera settings and movements to optimize the visual presentation of the game. This logic can analyze real-time game data and predefined criteria to make dynamic decisions about camera angles, transitions, and framing. Components of this analysis may include scene analysis, where the system evaluates the current context, such as the position of characters, action intensity, and environmental features, and the like. It could then use this analysis to choose the most appropriate camera angle and movement style, ensuring that important actions and details are highlighted effectively. In certain embodiments, this analysis may be done by evaluating different scores attached or otherwise associated with each available camera point within a gaming environment.

In a number of embodiments, a virtual cinematographer logic 342 may consist of heuristics and decision-making processes designed to simulate the artistic choices made by a human cinematographer. The virtual cinematographer logic 342 may, in various embodiments, analyze real-time game data and pre-defined cinematic rules to automatically control camera angles, movements, and transitions, enhancing the storytelling and gameplay experience. This logic may incorporate various data inputs, such as lens data, movement data, base score data, framing data, camera type data, cameraman data, and camera weight data, to create visually appealing and contextually appropriate scenes.

In more embodiments, the virtual cinematographer logic 342 can dynamically adjust the camera or selection of a pre-established camera point based on in-game events, character actions, and environmental cues. For example, it could switch to a close-up during a dramatic dialogue, pan to follow a fast-moving character, or adopt a wide-angle shot to showcase expansive landscapes or other points of interest. In further embodiments, the virtual cinematographer logic 342 may also account for cinematic techniques such as rule of thirds, leading lines, and depth of field to ensure aesthetically pleasing compositions. Additionally, this logic would manage transitions between different camera angles and movements smoothly, maintaining continuity and immersion.

In yet more embodiments, a virtual cameraman logic 344 may comprise a set of heuristics and rules designed to mimic the decisions, sounds, and movements of a human cameraman, creating a dynamic and immersive visual experience. This logic can process various types of camera data 370, such as lens settings, movement parameters, and framing preferences, to determine the best camera angles and transitions in real-time. In certain embodiments the virtual cameraman logic 344 may utilize the game's context, such as the player's actions, environmental changes, and narrative elements, to adjust the camera's position and orientation realistically.

The virtual cameraman logic 344 may also incorporate elements like camera type and cameraman data to simulate different styles of camera work, such as steady shots, handheld movements, or dramatic zooms and pans. Additionally, certain embodiments of the virtual cameraman logic 344 can evaluate can incorporate sounds and other action or indications that a real person is behind the game camera, increasing the overall level of realism within the game scene.

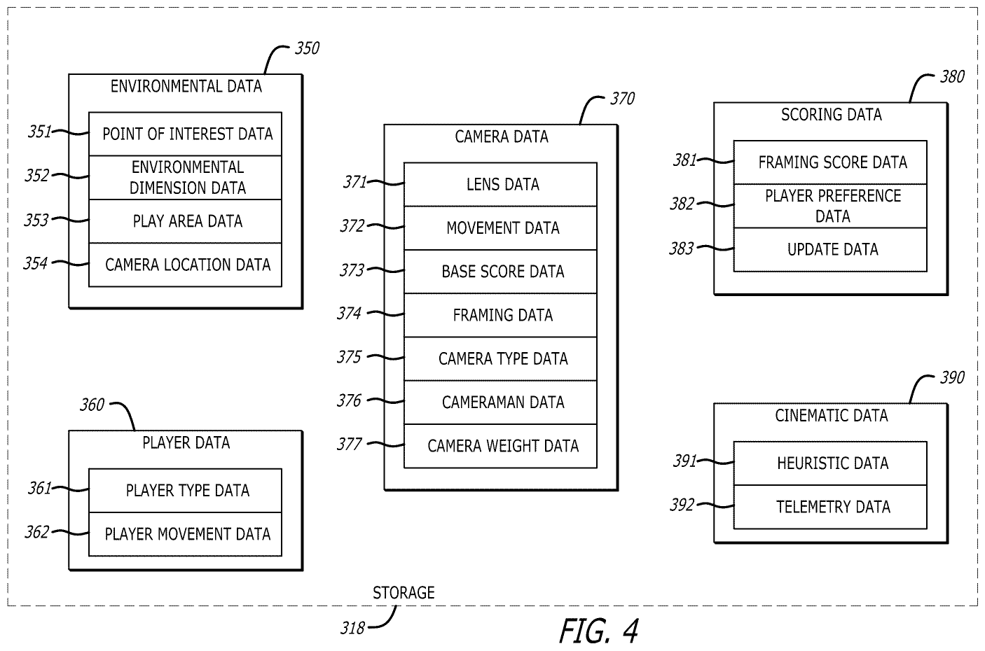

As discussed above in the embodiment depicted in FIG. 2, and in more detail below in the embodiment depicted in FIG. 4, the fully controlled camera system 300 may include a number of different types of available data to work with. These data may include environmental data 350 that can capture various aspects of the gaming environment being rendered and utilized. There may also be player data 360 that can describe different attributes of the player and their current avatar. Camera data 370 can be configured to provide various types of information related to how a camera may be set up, moved, and selected within a gaming environment. Scoring data 380 can help guide the system to determine what the correct or optimal score would be for each camera. Finally, cinematic data 390 can provide any specific heuristic or telemetry data that can better indicate what camera would be best be selected in a fully controlled camera system 300.

Although a specific embodiment for an abstract block diagram of the components of a fully controlled camera system 300 suitable for carrying out the various steps, processes, methods, and operations described herein is discussed with respect to FIG. 3, any of a variety of systems and/or processes may be utilized in accordance with embodiments of the disclosure. For example, the memory 345 can be an active memory that has the logics loaded/configured and is currently executing the various steps, processes, and/or methods described herein. In some embodiments, the memory 345 may be in a virtual environment such as a cloud-based game administration environment, or it may be distributed across a variety of network devices or servers. The elements depicted in FIG. 3 may also be interchangeable with other elements of FIGS. 1-2 and 4-12 as required to realize a particularly desired embodiment.

Referring to FIG. 4, an abstract block diagram of the data within a storage 318 of a fully controlled camera system in accordance with various embodiments of the disclosure is shown. In many embodiments, environmental data 350 may comprise various sub-types of data like point of interest data 351, environmental dimension data 352, play area data 353, and/or camera location data 354. However, as those skilled in the art will recognize, many other types of data may be included as well depending on the specific game and/or application.

In a number of embodiments, point of interest data 351 can include elements within the game environment that the camera should focus on or highlight. This data can encompass characters, significant objects, and interactive elements that are crucial to the gameplay or narrative. It may also include dynamic events, such as explosions, actions performed by the player or non-player characters, and environmental changes like weather effects. Additionally, point of interest data 351 may take into account contextual cues, such as dialogue or mission objectives, such that the camera may capture the most relevant and engaging aspects of the scene. This data can be formatted in a number of ways but may be a list of coordinates within a three-dimensional space and a corresponding value or score.

In more embodiments, environmental dimension data 352 can be configured as information about the game world's spatial and contextual characteristics. This data may include the size, shape, and layout of various game environments, such as rooms, outdoor areas, and obstacle placements, which helps the camera system navigate and frame scenes effectively. It can also comprise the dynamic elements within the environment, like moving objects, lighting conditions, and weather effects, to adjust camera settings and movements accordingly. Additionally, environmental dimension data 352 may account for interactive elements and potential player actions within these spaces, ensuring that the camera can anticipate and smoothly follow the player's movements while maintaining optimal angles and visibility of key gameplay moments.

In additional embodiments, play area data 353 can comprise various information for determining how a camera may be positioned and moved within the game's environment. This data may also include the spatial dimensions of the game environment where the player may traverse, including, but not limited to, boundaries, obstacles, and key landmarks, which can be utilized to help a camera navigate the environment without clipping through objects or getting obstructed. In certain embodiments, the play area data 353 may also incorporate dynamic elements like the location and movement patterns of characters, enemies, and interactive objects, ensuring they are effectively captured within the frame. Additionally, play area data might include designated points of interest or focal points that the camera should highlight during specific events or actions.

In further embodiments, camera location data 354 may include detailed information about the camera's spatial coordinates within the game environment, its orientation or rotation angles (pitch, yaw, and roll), and its movement vectors. This data can ensure that the camera can dynamically and accurately follow the action, providing optimal viewing angles and perspectives. In certain embodiments, the camera location data 354 may also encompass the camera's distance from the subject, height relative to the ground, and any constraints or boundaries to prevent clipping through objects or environments. Additionally, location data might include predefined waypoints or paths for scripted sequences, ensuring smooth transitions and cinematic shots.

In still more embodiments, player data 360 can include player type data 361 and player movement data 362. Player data 360 may be formatted as a list of attributes or parameters. In some embodiments, the player data 360 be a structure with a set of values that can be interpreted by other logic to implement one or more actions.

In yet further embodiments, player type data 361 may be configured as various attributes and preferences that define the player's or the player's avatar interaction style, skill level, and/or behavior patterns within the game. This data could encompass the player's preferred control settings, such as sensitivity levels for camera movement and specific input configurations. In some embodiments, the player type data 361 may also include information about the player's skill level, which can be inferred from gameplay statistics like reaction times, accuracy, and completion rates. Additionally, player type data 361 could track behavioral patterns, such as tendencies to explore, engage in combat, or focus on story-driven elements.

In still additional embodiments, player movement data 362 can comprise a comprehensive set of information detailing the player's actions and position within the game environment. In certain embodiments, this data may encompass the player's coordinates (X, Y, Z) in a three-dimensional virtual world for example, as well as direction and speed of the movement, and any changes in posture or stance (such as crouching, jumping, or lying prone). It may also include the player's interaction with the environment, such as climbing, swimming, or using objects. Additionally, player movement data 362 may capture or otherwise be modified to reflect input from controllers or keyboards, or other in-game actions.

In many embodiments, camera data 370 may include data related to the virtual camera rendering the game environment, such as, but not limited to, lens data 371, movement data 372, framing data 374, camera type data 375, cameraman data 376, and camera weight data 377. In various embodiments, other factors related to the camera, such as the base score data 373 can reflect a minimum score level for evaluation of a camera by a virtual editor logic.

In a number of embodiments, lens data 371 may comprise several elements that can define how the camera captures the visual scene. This may include the virtual focal length, which determines the field of view and how zoomed in or out the image appears. Aperture settings, which can control the depth of field and the amount of light entering the virtual lens, may also be part of lens data 371. Additionally, it can include information about focus distance, which affects how sharp or blurred objects appear at different distances. Lens data 371 might also capture lens distortion parameters to simulate the curvature or warping effects seen with certain types of lenses.

In more embodiments, movement data 372 can be configured as several components that may dictate how the camera transitions and orients itself in the game environment. This can include the camera's position coordinates (X, Y, Z) relative to the scene, ensuring it can move fluidly to follow the action or adjust perspective. It may also encompass the direction and velocity of the camera's movement, determining how quickly and smoothly it can pan, tilt, or zoom to new viewpoints. Additionally, rotational data can specify the camera's orientation in terms of pitch, yaw, and roll, allowing it to angle correctly and maintain a steady focus on important game elements. This data might also include interpolation methods to ensure smooth transitions between different camera positions and angles, as well as collision detection to prevent the virtual camera from passing through objects.

In additional embodiments, base score data 373 can relate to any initial settings or scores that are assigned to specific cameras. As discussed below, received telemetry data 392 and other update data 383 may require adjustment of the base score data 373 for specific virtual camera points within the game environment. In this way, certain issues can be addressed such as a camera failing to trigger in a fully controlled camera game, or a virtual camera being relied on for too long, which can remove some of the realism of that area of the game.

In further embodiments, framing data 374 may be comprised of several elements that can ensure the visual composition is aesthetically pleasing and functionally effective. In some embodiments, the framing data 374 can include the positioning of primary and secondary subjects within the frame, ensuring that key characters, objects, or actions are properly centered or placed according to various cinematic guidelines. Framing data 374 may also involve determining the appropriate zoom level and field of view to capture necessary details while maintaining contextual awareness of the surroundings. Framing data 374 can also be configured to consider the balance and symmetry of visual elements, managing empty space (negative space) around subjects to avoid cluttered or overly sparse scenes. Additionally, in certain embodiments, framing data 374 can take into account dynamic adjustments, such as re-framing during fast movements or significant scene changes, to keep important elements within the viewer's focus consistently.

In still more embodiments, camera type data 375 can comprise various attributes and settings that may define the specific characteristics and behaviors of the camera being simulated within the game. This can include the camera model, which dictates its physical properties such as size, shape, and weight. It may also encompass the type of lenses that may be used, such as wide-angle, telephoto, or fisheye, which affects the field of view and the degree of distortion. Additionally, in certain embodiments camera type data 375 can include preset configurations for different filming styles, such as stationary, handheld, drone, or Steadicam, each with unique movement and stabilization characteristics. This data may also specify the camera's response to environmental factors like lighting conditions and motion, as well as any built-in effects like zoom capabilities or focus adjustments.

In more further embodiments, cameraman data 376 may include, within the context of a virtual cameraman logic, may be comprised of parameters and attributes that simulate the behavior and decisions of a human camera operator. This data can include predefined movement patterns and styles, such as smooth tracking shots, dynamic panning, or quick zooms, based on the narrative or gameplay requirements. It may also encompass reaction times and sensitivity settings to mimic how a real cameraman would adjust to sudden changes in the scene, such as quick player movements or unexpected events. Additionally, cameraman data 376 can include preferences for framing, such as maintaining a certain distance from the player or focusing on specific elements within the environment as well as sound which can be reflected in additions to the game's sound generated during gameplay.

In still additional embodiments, camera weight data 377 can be associated with information that simulates the physical characteristics and inertia of the virtual camera, contributing to more realistic and dynamic camera movements. This data may include the simulated mass of the camera, which affects how it accelerates, decelerates, and responds to movements or changes in direction. It also encompasses the center of gravity and distribution of weight, which influence the balance and stability of the camera. Additionally, camera weight data 377 may account for the damping and friction parameters, which determine how smoothly the camera transitions between movements and how it handles sudden stops or starts.

In numerous embodiments, scoring data 380 can include various types of data that can affect the scoring of each camera within a gaming environment. This may include, for example, framing score data 381, player preference data 382, and update data 383. However, as those skilled in the art will recognize, other types of scoring data 380 may be utilized as needed.

In a number of embodiments, framing score data 381 may comprise an evaluation and ranking for different camera perspectives based on their effectiveness in framing key elements within the gaming environment. This data can be configured to assess the composition of each shot, ensuring that important subjects, such as the player character, NPCs, and significant objects, are properly positioned according to various cinematic principles like the rule of thirds, balance, focus, etc. An analysis of real-time game scenes can be done to assign scores to various camera angles or camera points based on their ability to highlight crucial action or narrative elements clearly and engagingly.

In more embodiments, player preference data 382 can relate to information tailored to individual player choices and habits, influencing how the camera system adjusts to enhance their gaming experience. This data can include preferred camera angles and perspectives, such as a first-person view, third-person over-the-shoulder view, or top-down perspective. These preferences can be communicated in the form of “hints” such as pushing one or more inputs, etc. The player preference data 382 can also take into account the player's adjustments to camera sensitivity and movement speed, reflecting their comfort level and play style. Additionally, player preference data 382 can capture preferred zoom levels, focus points during different gameplay scenarios (combat, exploration, cutscenes), and any specific settings related to camera behavior, such as automatic panning or manual control options.

In further embodiments, update data 383 can comprise information necessary to keep the camera system and overall game experience current and functioning optimally. This may include patches and bug fixes to address any issues or glitches that have been identified in the camera system or game mechanics. It may also encompass new features and enhancements that improve camera control, such as additional camera angles, improved AI for the virtual cameraman. Furthermore, update data may contain adjustments based on player feedback and telemetry data 392, such as refined camera movement to better match player preferences or optimized performance for different hardware configurations.

In additional embodiments, cinematic data 390 may comprise various data related to how virtual cameras can operate to comport with various photographic and cinematography principles, which can make the game experience seem more realistic and/or more cinematic. In some embodiments, the cinematic data 390 may include heuristic data 391 as well as telemetry data 392.

In still more embodiments, heuristic data 391 may include sets of commands, processes, and/or methods related to various principles that can aide in creating a more realistic and cinematic gaming experience. For example, heuristic data 391 may comprise various “if this, then that” transforms that can indicate when various actions should occur in response to other types of input or game states. In certain embodiments, heuristic data 391 may be formatted as an input into one or more machine learning processes for generation of an inference or output.

In yet further embodiments, telemetry data 392 can be associated with data that has been gathered from play tests or other playthroughs of the game by players. As players play the game, each playthrough may be unique depending on their choices as the player. Over time, this data can be captured in a private (i.e., non-identifying) manner and aggregated into telemetry data 392. This telemetry data 392 can subsequently be utilized to gather insight into the game experience, compare it to a model or desired experience, and generate decisions or update data 383 that can be useful in correcting or otherwise better guiding players through a more optimized game play experience.

Although a specific embodiment for an abstract block diagram of the data within a storage 318 of a fully controlled camera system suitable for carrying out the various steps, processes, methods, and operations described herein is discussed with respect to FIG. 4, any of a variety of systems and/or processes may be utilized in accordance with embodiments of the disclosure. For example, the data types described herein can vary depending on the type of application deployed and/or desired. For example, each specific data type may be concatenated into one data structure or be broken up into multiple additional data structures. Those skilled in the art will recognize that data can be formatted in a variety of ways beyond the specific embodiment depicted in FIG. 4. The elements depicted in FIG. 4 may also be interchangeable with other elements of FIGS. 1-3 and 5-12 as required to realize a particularly desired embodiment.

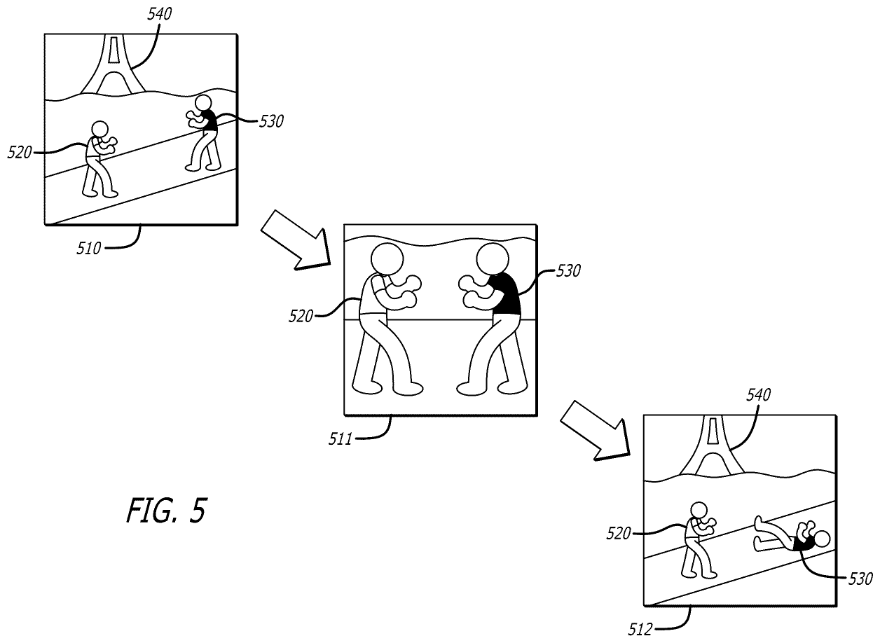

Referring to FIG. 5, a conceptual illustration of utilizing points of interest in a fully controlled camera system in accordance with various embodiments of the disclosure is shown. In many embodiments, a fully controlled camera system can utilize points of interest within a game scene to intelligently choose which camera points to render from, enhancing the overall player experience by maintaining focus on key elements and actions. Points of interest (POIs) are specific locations or objects within the game environment that are critical to the gameplay, narrative, or visual appeal. These can include characters, interactive objects, mission objectives, and significant environmental features.

In a number of embodiments, when determining a more optimal camera point, the system may first identify and prioritize any available POIs based on the current context of the game and/or environment. For example, during a combat sequence, the primary points of interest might be the player character, enemies, and key environmental hazards. In a narrative scene, POIS could include characters engaged in dialogue and important visual details that convey the story. In more embodiments, the fully controlled camera system may constantly update the list of active POIS as the player moves through the game and interacts with different elements and environments.

Using this dynamic list of POIs, the fully controlled camera system can evaluate the available camera points to determine which one provides the best view of various gameplay elements. In various embodiments, each camera point can be scored based on its ability to capture various gameplay aspects, including the prioritized POIs. This scoring may consider factors such as visibility, framing, and the angle of view relative to the POIs. The camera that scores highest in these evaluations is selected to render the scene, ensuring that the player has the most relevant and engaging perspective at all times. As these scores change, different triggers and/or thresholds can be configured to dynamically and automatically move the camera view around the scene in an engaging and non-jarring way.

In certain embodiments, the fully controlled camera system can anticipate upcoming POIs based on the player's actions and the game's progression. For instance, if the player is moving towards a key objective or about to interact with an important character, the camera system can preemptively adjust to a camera point that optimally frames these anticipated POIS. This predictive adjustment may help maintain a seamless visual experience and keeps the player focused on the most significant aspects of the game.

Furthermore, as described herein, the fully controlled camera system can be configured to incorporate cinematic techniques to enhance the presentation of POIs. For example, various automatic cuts may utilize zooming, panning, and/or tilting to draw attention to specific elements or create a dramatic effect. By intelligently leveraging points of interest and dynamically adjusting the weights associated with each of the camera points, the fully controlled camera system can significantly enhance the storytelling, gameplay, and visual immersion, providing a more cohesive and cinematic experience for the player.

In the embodiment depicted in FIG. 5, a first frame 510 can be generated prior to a player character 520 engages in a fight with an enemy character 530. The current framing includes in the background a first point of interest 540, which is the Eiffel Tower in this instance. As the player 520 and enemy 530 engage in fighting, the weights of the camera point evaluations are configured such that the close-up of the fight in the second frame 511 is determined to be more engaging and is thus cut to. Upon disengaging the fight, the game state may change, or, in certain embodiments, the weights associated with the scene may change such that the camera view in the third frame 512 is now more optimal, which again includes the first point of interest 540. In this way, cameras selected in the scene can best deliver the gameplay narrative and experience that is envisioned by the developers to maximize player emersion within the story and environment.

Although a specific embodiment for a conceptual illustration of utilizing points of interest in a fully controlled camera system suitable for carrying out the various steps, processes, methods, and operations described herein is discussed with respect to FIG. 5, any of a variety of systems and/or processes may be utilized in accordance with embodiments of the disclosure. For example, the transition between the first frame 510, second frame 511, and third frame 512 may be any type of cut such as a straight cut, but may also be a zoom in and out. A virtual editor logic may be configured to best make those decisions in order to facilitate a more cinematic feel, keeping the player engrossed in the story and gameplay. The elements depicted in FIG. 5 may also be interchangeable with other elements of FIGS. 1-4 and 6-12 as required to realize a particularly desired embodiment.

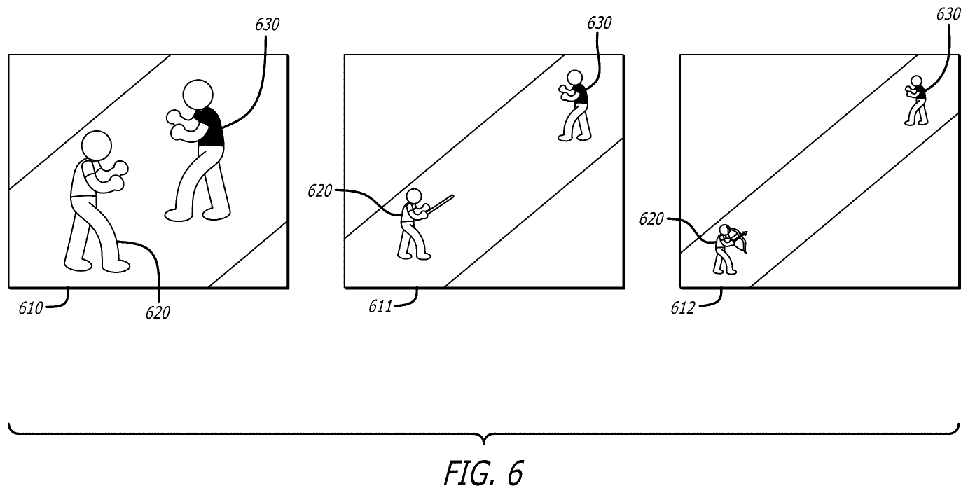

Referring to FIG. 6, a conceptual illustration of utilizing character traits in a fully controlled camera system in accordance with various embodiments of the disclosure is shown. In many embodiments, a fully controlled camera system can take various dynamic elements into account when choosing how to frame a camera cut or other change. These elements may include different aspects related to player choice or other adjustable settings that may be selected or changed by a player at any time during gameplay.

In the embodiment depicted in FIG. 6, a player 620 is encountering an enemy 630. However, the player may select from a variety of different weapons or attack strategies. Each type of attack can require the camera to adjust dynamically to provide the best possible view, ensuring that the player can clearly see and engage with the action. For example, in the first frame 610, the player is engaging in hand-to-hand combat with the enemy 630. In a number of embodiments, hand-to-hand fighting may need the camera to be positioned relatively close to the player character to capture the intense, fast-paced combat. This proximity can allow the player to see detailed movements and reactions, making it easier to execute precise attacks and dodges. The camera might cut in closer to emphasize punches, kicks, and grapples, highlighting the fluidity and impact of each move.

In the second frame 611, the player 620 has a medium range weapon, specifically a bo long staff for combat. For this type of attack, the camera may be adjusted farther out in various embodiments to accommodate the extended reach of the weapon. This type of combat can benefit from a balance between being close enough to see the player character's detailed movements and far enough to capture the staff's full range of motion. In some embodiments, the camera may need to zoom or cut back slightly and adjust its angle to ensure that both the player character and their target are visible within the frame.

Finally, in the third frame 612, the player 620 is engaging the enemy 630 with a bow and arrow. In these embodiments, the bow and arrow attacks present a different set of requirements for the fully controlled camera system. Here, the camera may be configured to zoom out even further to cover the distance between the player 620 and their potential target enemy 630. This wider field of view can be useful for allowing the player to aim accurately and track the arrow's trajectory. The camera might cut to an over-the-shoulder view or a third-person perspective that shows both the archer and the target area. Additionally, in certain embodiments, the camera system can employ cinematic techniques such as following the arrow in flight to emphasize the precision and impact of the shot.

These examples highlight how different player choices, movements, and designs can affect the selection and/or framing of different cameras during gameplay. In more embodiments the fully controlled camera system may also consider environmental factors that affect visibility. For example, in dense forest settings or crowded urban areas, the camera may be configured to navigate around obstacles and provide a clear line of sight. These choices can be factored into one or more logics that can make such selections automatically without player input.

Although a specific embodiment for a conceptual illustration of utilizing character traits in a fully controlled camera system suitable for carrying out the various steps, processes, methods, and operations described herein is discussed with respect to FIG. 6, any of a variety of systems and/or processes may be utilized in accordance with embodiments of the disclosure. For example, other dynamic player choices can affect camera framing, such as, but not limited to, player clothing and other equipment, the number of players, enemies, or non-playable characters, traveling with the player, mode of travel (foot, car, plane, etc.), and the like. The elements depicted in FIG. 6 may also be interchangeable with other elements of FIGS. 1-5 and 7-12 as required to realize a particularly desired embodiment.

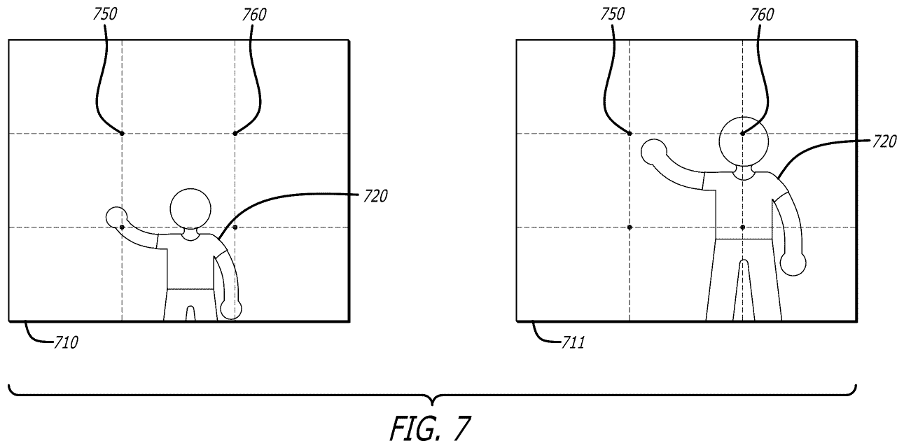

Referring to FIG. 7, a conceptual illustration of virtual camera framing using cinematographic principles in accordance with various embodiments of the disclosure is shown. In many embodiments, selecting and scoring a camera for optimal viewing in a game environment can be influenced by various cinematography principles. These principles can ensure that the visual storytelling is not only engaging but also enhances the player's understanding and immersion within the game world. Cinematography principles such as framing, composition, camera movement, and depth of field play roles in determining which camera angle will provide the best player experience. Other known principles such as not violating the one-hundred-eighty degree rule, can be adhered to for mimicking known movie styles that can further enhance the perceived quality of the game play.

In a number of embodiments, framing principles can be adhered to. Framing can involve the placement of subjects within the camera's virtual viewfinder. A well-framed shot can ensure that the main elements, such as the player character, enemies, and interactive objects, are clearly visible and appropriately positioned. Composition principles like the rule of thirds can guide this process, dividing the frame into nine equal segments and placing critical elements along these lines or their intersections.

This technique is shown in the embodiment depicted in FIG. 7. Specifically, in the first frame 710, the subject 720 is positioned within the near center of the first frame 710. The rule of thirds overlay creates some ideal intersection points such as the upper left intersection point 750 and upper right intersection point 760, both of which are not intersected by the subject 720. However, in the second frame 711, the camera has been repositioned such that the subject 720 is now intersecting on the upper right intersection point 760, satisfying the rule of thirds. By utilizing this technique, a more balanced and visually pleasing shot can be created that may draw the player's attention to important areas of the screen.

Other cinematic techniques can be utilized based on the current environment and available camera point locations. For example, smooth and deliberate camera movements can enhance the fluidity of gameplay and maintains the player's immersion. Cinematic techniques such as panning, tilting, and tracking may help follow the player's actions and maintain focus on dynamic elements within the game. A camera that moves naturally and responds to in-game events without abrupt or jarring transitions will increase the overall immersion of the game to the player. Additionally, camera movements that simulate human-operated cameras, adding subtle shakes or adjustments, can also increase the sense of realism and immersion, making the gameplay experience more engaging.

In additional embodiments, by manipulating depth of field, a camera can highlight specific elements while subtly blurring the background or foreground, guiding the player's attention to where it is most needed. In further embodiments, effective lighting and shadows can add cinematic depth and mood to the game environment such that lighting should be configured to not only illuminate the scene but also create contrast and highlight textures. In still more embodiments, the choice of camera angles can significantly affect how scenes are perceived. For example, higher angles can make characters appear vulnerable, while lower angles can convey power and dominance. A variety of perspectives, such as over-the-shoulder shots, first-person views, or wide-angle scenes, provide different levels of engagement and storytelling potential. A fully controlled camera system can be configured to switch between these angles depending on the context and narrative needs. These types of camera scoring can occur based on various weights or restrictions the developers establish in the game environment or scene such that the desired emotion from the player can be converted into a score that can be used to rank different camera angles associated with conveying those feelings.

Although a specific embodiment for a conceptual illustration of virtual camera framing using cinematographic principles suitable for carrying out the various steps, processes, methods, and operations described herein is discussed with respect to FIG. 7, any of a variety of systems and/or processes may be utilized in accordance with embodiments of the disclosure. For example, any combination of cinematography principles or other immersive rules that can aid in storytelling and player emersion may be utilized in scoring of different camera points within a game environment. The elements depicted in FIG. 7 may also be interchangeable with other elements of FIGS. 1-6 and 8-12 as required to realize a particularly desired embodiment.

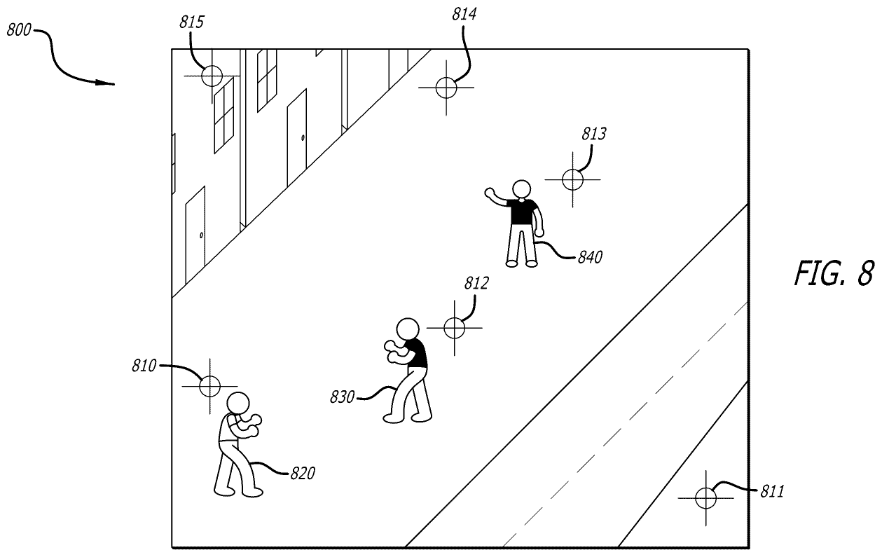

Referring to FIG. 8, a conceptual illustration of a game environment 800 with a plurality of available camera points 810-815 in accordance with various embodiments of the disclosure is shown. In many embodiments, each game environment or scene may be configured with a plurality of camera points where a camera may be generated or otherwise configured to render a scene. These camera points may be dynamically added to a scene, such as camera points that are relative to the position of a player or other character. However, in a number of embodiments, each scene may have a plurality of fixed camera points that are placed within the scene by the developers.

For example, in the embodiment depicted in FIG. 8, the game environment 800 has a player 820 ready to engage with a first enemy 830 while a second enemy 840 looks on. The environment is set on the side of a street and can have a plurality of camera points 810-815 positioned with the scene at any given time. Each camera point 810-815 may be selected at any time to position a camera at to start rendering the scene for the player, effectively generating a cut within the scene. In additional embodiments, adding these different camera points 810-815 within a game environment can be a detailed and strategic process. This can ensure that the camera points 810-815 are positioned to capture the action effectively, enhancing both gameplay and visual storytelling.

In some embodiments, the first step for placing camera points within an environment 800 can involve planning and design. Game developers can map out the scene, identifying key locations where significant actions may occur. For a fight scene on the side of the road, this might include the player's initial position, enemy spawn points, and areas where the combat is likely to move. During this planning phase, the development team may consider the environment's layout, potential obstacles, and the flow of action to determine optimal camera placement. They may also decide on the types of shots that would best capture the intensity and dynamics of the fight, such as close-ups, wide angles, and over-the-shoulder shots.

Next, the camera points can be strategically placed within the game environment. Placement may be entry into a data structure configured for camera point listings, or may be points relative to other locations within the game environment. For example, an “over-the-shoulder” camera would need to be dynamically moved to be over the shoulder of the player or character as they move throughout the environment. In additional embodiments, once the camera points are placed, they can be integrated into the game engine with specific parameters, including position, orientation, field of view, depth of field, and other parameters. These parameters can be fine-tuned to ensure that each camera point provides the desired perspective and visual quality. The integration process may also involve setting up the camera logic, which can dictate how and when the camera points will switch based on the player's actions, the progression of the fight, changes in the overall camera scores, etc.

In still more embodiments, testing and iteration can be performed. The specific scene can be played through multiple times to evaluate the effectiveness of the camera points. Testers may provide feedback on the clarity of the action, the fluidity of camera transitions, and the overall visual experience. Based on this feedback, adjustments can be made to camera point positions, angles, and transition logic. For example, if a particular camera point consistently provides poor visibility during critical moments, it may be repositioned or replaced.

In still further embodiments, refinement can occur to ensure the environment 800 responds appropriately during the gameplay. This may include programming or otherwise adjusting the weights of the camera system to prioritize certain camera points that best capture the current action. For example, when the player executes a special move or engages multiple enemies simultaneously, the system might switch to a camera point that provides a dramatic, close-up view of the action. Conversely, when the player is moving between engagements or assessing the battlefield, a wider angle might be used to provide better situational awareness.

In the embodiment depicted in FIG. 8, the player 820 is associated with a first camera point 810 that is set up to be a dynamic over-the-shoulder camera point. This first camera point 810 can move along with the player through the scene. A second camera point 811 can be configured to be located across the road. This second camera point 811 could capture a side profile of the player 820 and either the first enemy 830 and/or second enemy 840. However, this view may become occluded by virtual cars that drive by during the scene. Thus, the camera score for the second camera point 811 may be lower than other camera points.

The environment 800 depicted in FIG. 8 also includes a first enemy 830 who also has a third camera point 812 associated with them that may also be configured as an over-the-shoulder camera that moves dynamically with the first enemy 830. Similarly, the second enemy 840 may have a fourth camera point 813 associated with them that is also dynamic in nature. A fifth camera point 814 can positioned toward the other end of the environment 800 which could capture the viewpoint of the enemies 830, 840 attacking the player 820. This fifth camera point 814 may, for example, be configured with a cinematic camera with a low focal depth, while the first camera point 810, third camera point 812, and fourth camera point 813 are configured more like handheld cameras with corresponding lens and weight settings. Finally, the environment 800 may have a sixth camera point 815 that can be selected to gain a more overhead view of the fight between the player 820 and the first enemy 830 and/or second enemy 840. Each of these camera points 810-815 may be selected at any time during the play through of the game environment 800. The selection or cut to each camera point can be done in response to an event that necessitates a cut or through an evaluation of camera scores that indicate that, based on the current game play state, one camera point would be sufficiently superior to render from.

Although a specific embodiment for a conceptual illustration of a game environment with a plurality of available camera points suitable for carrying out the various steps, processes, methods, and operations described herein is discussed with respect to FIG. 8, any of a variety of systems and/or processes may be utilized in accordance with embodiments of the disclosure. For example, every scene may have a similar combination of dynamic and/or static camera points. The elements depicted in FIG. 8 may also be interchangeable with other elements of FIGS. 1-7 and 9-12 as required to realize a particularly desired embodiment.

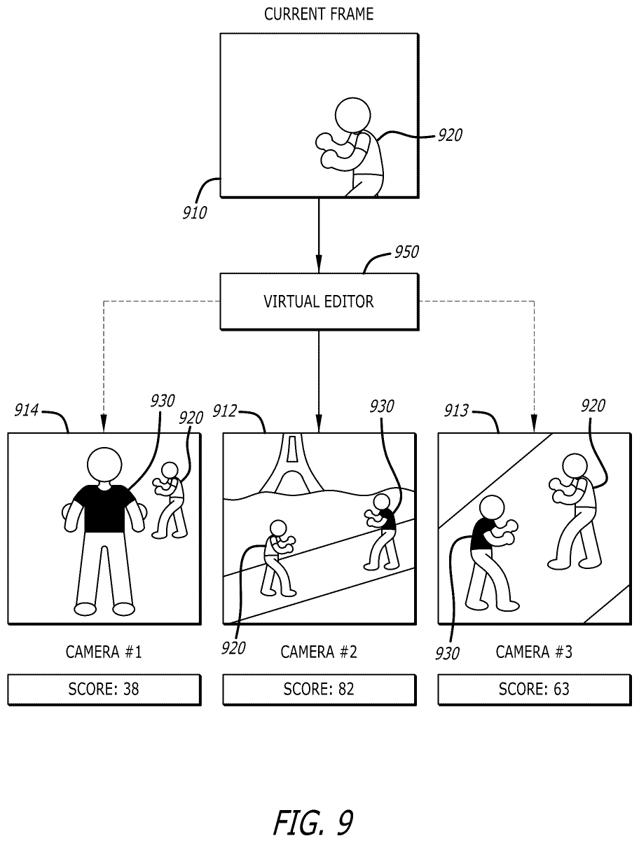

Referring to FIG. 9, a conceptual illustration of a virtual editor 950 in a fully controlled camera system in accordance with various embodiments of the disclosure is shown. A virtual editor logic 950 can operate as an intelligent system that continuously evaluates the visual and contextual data of the game in real-time, ensuring that the most engaging and clear perspectives are presented to the player.

The virtual editor logic 950 can begin by assessing the current frame 910, examining key elements such as the player 920 and their position, the actions of enemies, and the overall layout of the environment. The virtual editor logic 950 can, in certain embodiments, identify points of interest and evaluate the current frame or camera's effectiveness in capturing these elements. Based on this assessment, the virtual editor logic 950 can calculate a score for the current frame 910 and associated camera, factoring in criteria such as framing quality, clarity of action, player and enemy visibility, and adherence to cinematography principles like composition and focus, among others. In some embodiments, if the score falls below a certain threshold, indicating that the current camera is not providing the optimal view, the virtual editor logic 950 can scan available alternative camera points. In the embodiment depicted in FIG. 9, that can include a first camera 914, a second camera 912, and a third camera 913.

In numerous embodiments, the first camera 914 can be an over-the-shoulder shot from behind the enemy 930 towards the player 920. The current score on this camera is thirty-eight, but changes every cycle, which may be any change in game state or over a fixed interval of time. Likewise, the second camera 912 is a point of interest shot of the player 920 on the left and the enemy 930 on the right. The score for that camera is at eight-two. Finally, the third camera 913 is configured as a close up between the player 920 and the enemy 930 from the reverse side. That third camera 913 currently has a score of 63 which may also change in response to any change in game play state.

In still additional embodiments, each alternative camera can be scored based on its potential to improve the visual presentation of the scene. The virtual editor 950 can evaluate how well each camera can capture the important elements, maintain smooth transitions, and enhance the player's understanding and engagement with the action. It may also consider various factors, such as whether a camera provides a better angle of the player's movements, offers a clearer view of incoming threats, or creates a more immersive and dramatic perspective.

Once the virtual editor 950 identifies the highest-scoring alternative camera, it may initiate a cut to this new camera angle. In the embodiment depicted in FIG. 9, the virtual editor logic 950 has chosen camera two (i.e., the score is the highest of the available other camera points). Any subsequent transition can be executed smoothly to avoid disrupting the player's experience. This can involve cinematic techniques like match cuts or cross-fades, ensuring the change in perspective feels natural and enhances the storytelling and gameplay flow.

In still more embodiments, the virtual editor logic 950 can utilize a continuous evaluation of the current frame to determine the effectiveness of the existing camera angle. By scoring and comparing alternative cameras based on real-time data and cinematographic principles, it can select and cut to the most optimal camera, ensuring that the player's visual experience is always clear, engaging, and immersive.

Although a specific embodiment for a conceptual illustration of a virtual editor 950 in a fully controlled camera system suitable for carrying out the various steps, processes, methods, and operations described herein is discussed with respect to FIG. 9, any of a variety of systems and/or processes may be utilized in accordance with embodiments of the disclosure. For example, there may be a large number of alternative cameras to pick from. In more embodiments, the virtual editor logic 950 is incorporated into other logics and can be utilized to manage the different camera points. The elements depicted in FIG. 9 may also be interchangeable with other elements of FIGS. 1-8 and 10-12 as required to realize a particularly desired embodiment.

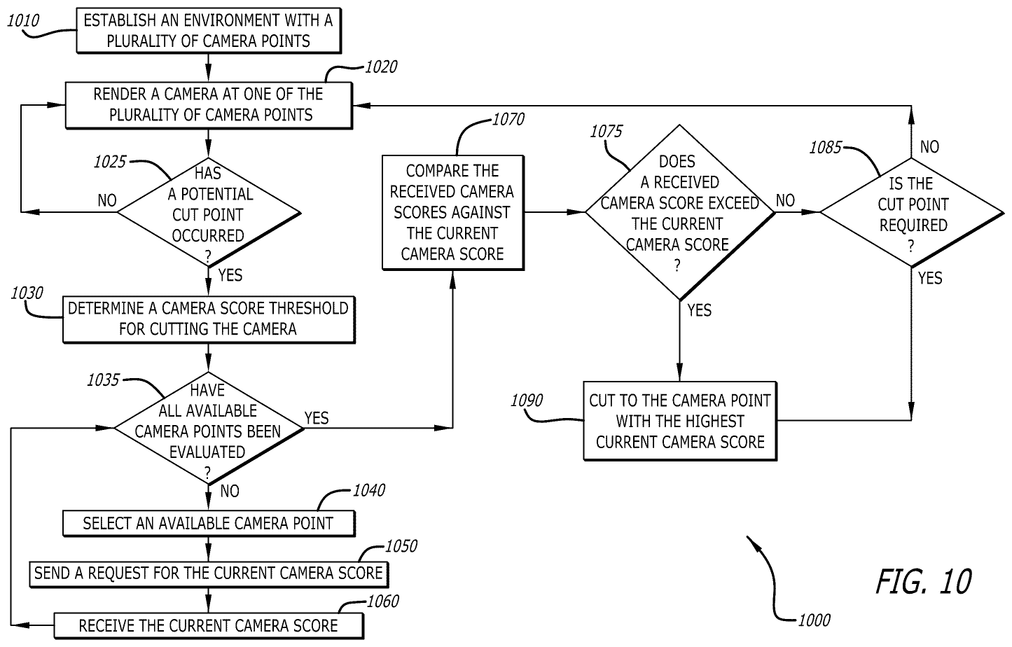

Referring to FIG. 10, a flowchart of a process 1000 for evaluating preexisting camera scores in accordance with various embodiments of the disclosure is shown. In many embodiments, the process 1000 can establish an environment with a plurality of camera points (block 1010). Establishing these game environments with a plurality of camera points can involve a detailed process where designers and cinematographers collaborate to map key areas and plan the cinematic approach for the game. This can include strategically placing camera points to capture optimal angles and views, considering factors like visibility, framing, and smooth tracking of player movement. Each camera point can be utilized by the game engine with specific parameters, allowing dynamic transitions based on gameplay conditions and player actions.

In a number of embodiments, the process 1000 can render a camera at one of the plurality of camera points (block 1020). A camera point in a game environment can have a camera associated with it, enabling the rendering of the game scene from that specific location. When the game engine determines that a particular camera point should be selected, the camera associated with that camera point is activated. The camera's parameters, such as position, orientation, field of view, and depth of field, can be configured to match the predefined settings of the camera point. Once activated, the camera can start rendering the game environment from its perspective, capturing all visual elements such as characters, objects, and scenery.

In more embodiments, the process 1000 can determine if a potential cut point has occurred (block 1025). Various events and scenarios can lead to a “cut point,” where the process 1000 can be configured to automatically transition to a different location or angle to enhance the player's experience or transition to a new scene/environment/cutscene, etc. For example, when the player enters a new area or gaming environment, a cut point may occur to provide an optimal overview of the new surroundings, helping the player orient themselves quickly. Significant gameplay moments, such as boss fights, major plot reveals, or important character interactions, might trigger camera cuts to emphasize the event's significance and enhance the narrative impact. During fast-paced action scenes like combat or chase sequences, frequent camera cuts can maintain a dynamic and engaging perspective, ensuring the player has a clear view of the action and any threats.

If it is determined that no potential cut point has occurred, the process 1000 can continue to render the camera at one of the plurality of camera points (block 1020). Typically, this is the same camera that has previously been utilized. In fact, this step can occur without a change in the current rendering or camera selection/processing of the current camera, such that the player may not be aware, and no cut occurs.

However, if it is determined that a potential cut point has occurred, then the process 1000 can determine, in various embodiments, a camera score threshold for cutting the camera (block 1030). The threshold score may be generated by assessing the current camera's performance across several criteria, such as framing quality, clarity of action, smoothness of movement, and alignment with player preferences. Additionally, player feedback and historical data on preferred camera settings can influence the threshold score, ensuring it reflects an optimal balance between technical performance and user experience. In some embodiments, the threshold can be set with a certain buffer to avoid a feedback loop where the process 1000 gets stuck in a series of quick cuts that are sub-optimal for player experience.

In further embodiments, the process 1000 can further determine if all available camera points have been evaluated (block 1035). A given game environment may be populated with a plurality of camera points that can host or otherwise render a virtual camera. If a cut is to occur, some or all of these available camera points within the scene or environment can be evaluated for a potential cut point.

If it is determined that all available camera points have not been evaluated, then the process 1000 can, in several embodiments, select an available camera point (block 1040). In a given scene, any number of camera points may be available. As discussed previously, each scene or gaming environment may have a number of pre-selected or established camera points. In certain embodiments, the process 1000 may be able to generate dynamic or unique camera points in relation to the current game state.

In additional embodiments, the process 1000 can send a request for the current camera score (block 1050). These requests can be formatted as a function call or may be triggered in response to an earlier step within the process 1000. It is contemplated that various embodiments may have one or more camera points generate scores dynamically such that a score is readily available when needed.

In still more embodiments, the process 1000 can receive the current camera score (block 1060). When one or more camera points have dynamically or continuously generated or otherwise evaluated camera scores available, receiving the scores may be faster than handling a request to generate a new camera score. However, as those skilled in the art will recognize, any mix of these methods may be utilized based on the needs of the current application and/or the available resources.

However, if it is determined that all available camera points have been evaluated, then the process 1000 can compare the received camera scores against the current camera score (block 1070). In a number of embodiments, the comparison can be done on a one-to-one basis, or may be done by sorting a list of values or tables such that a highest score is available or otherwise accessible. It is contemplated that any of a variety of data comparison methods may be utilized based on the current desired application. Once known, this highest generated score can be compared against the current camera score, which should preferably be formatted within the same scale or grade as the generated camera scores and/or threshold.

In yet further embodiments, the process 1000 can determine if the received camera score exceeds the current camera score (block 1075). This determination can be a simple evaluation of the address or data structure associated with the highest camera score. In some embodiments, the evaluation may require that the generated camera score not simply exceed the current camera score, but also a current camera score plus buffer value or the previously determined threshold. The choice of determination can be done in response to certain conditions or game states as desired by the developers.

If it is determined that the received camera score does exceed the current camera score, then the process 1000 may, in certain embodiments, cut to the camera point with the highest current camera score (block 1090). The cut point may be configured to generate a cut to a different or more optimal camera within the game environment, which can be determined by the camera point with the highest received or generated camera score. In some embodiments, the cut may be to the camera that has the highest score that also satisfies one other condition that is set as a restriction within the cut point (e.g., don't cut to the close-up camera, etc.). In some embodiments, this restriction can be indicated by adjusting the weight of one or more characteristics of the camera point. In additional embodiments, that restriction can simply be an indicator that a specific camera point should not be picked during the evaluation process.

However, if it is determined that the received camera scores do not exceed the current camera score, then various embodiments of the process 1000 may further determine if the cut point is required (block 1085). The potential cut point may occur but end up being determined that the current camera is still the best suited for rendering. However, various situations or game states may occur where a cut point is required from the current camera. For example, a camera point may have an enemy or other character occluding the camera view of the player. While the evaluation process may deem this camera to be insufficient via weight changes in the scoring process, the developers may want to make certain heuristics or other conditions that require that a cut occur away in certain situations.

If it is determined that the cut point is required, then many embodiments of the process 1000 can cut to the camera point with the highest received camera score (block 1090). In these cases, the process 1000 may simply select the camera point with the second highest score to cut to. However, if it is determined that the cut point is not required, the process 1000 can continue to render the camera at one of the plurality of camera points (block 1020). Again, this may transpire such that the player is not aware that a cut decision or the process 1000 even occurred.

In various embodiments, the full control camera logic can be configured to determine that a potential cut point has occurred in response to a variety of player-driven, narrative, or system-based triggers. A cut point can be determined when the player character enters a new game environment, prompting the system to select a camera point that provides a broad, establishing view of the new surroundings to orient the player. A cut point may also be determined if the current camera's line of sight to the player character or a point of interest becomes obstructed by an environmental object, such as a wall, column, or other piece of scenery. In such cases, the system is configured to find an alternative camera point with an unobstructed view.

Further, cut points can be determined based on specific gameplay actions and narrative events. For example, initiating combat, interacting with a key puzzle element, or engaging in a significant character interaction can trigger a cut point. These triggers allow the system to switch to a camera angle that better frames the action, enhances dramatic tension, or focuses the player's attention on a critical element. Similarly, a cut point may be determined during a scripted narrative sequence or a dialogue scene, where the full control camera logic automatically transitions between different pre-defined camera points to create a more cinematic and engaging presentation, similar to techniques used in film.

A cut point can also be determined based on a technical evaluation of camera scores. The full control camera logic may be configured to continuously or periodically generate a score for the currently active camera point based on factors such as framing composition, clarity, and stability. A cut point can be determined to have occurred if this current camera score falls below a predetermined quality threshold. Conversely, a cut point may also be determined if the score of an available, inactive camera point rises to exceed the current camera's score by a certain margin, indicating that a significantly better view is available. This score-based determination ensures the visual presentation remains at an optimal quality throughout gameplay.

Referring to the process 1000 of FIG. 10, in some embodiments, the full control camera logic operates within a video game environment that is rendered in real-time or near real-time. In certain embodiments, the evaluation of the plurality of camera points is performed continuously, with each camera point having a current camera score that is updated as the game state changes. A potential cut point (block 1025) can be determined when the score of the currently rendered camera falls below a predetermined threshold. In some embodiments, this score-based trigger, in addition to gameplay events like entering a new area or initiating a dialogue sequence, ensures the system is highly responsive. To enhance visual stability, in certain embodiments, after cutting to a camera point with the highest score (block 1090), the logic can establish a time-based buffer. During a subsequent evaluation, the system determines if a predetermined time has elapsed before allowing another cut, ensuring a minimum duration for each shot as part of the check to see if a cut is required (block 1085).

Although a specific embodiment for a flowchart of a process for evaluating preexisting camera scores suitable for carrying out the various steps, processes, methods, and operations described herein is discussed with respect to FIG. 10, any of a variety of systems and/or processes may be utilized in accordance with embodiments of the disclosure. For example, the determination of a threshold may be utilized to determine if any cut point should occur in the first place, thus triggering a process like the one depicted in FIG. 10. In these embodiments, the camera scores of the other camera points are continuously generated and compared against the threshold value until one camera point score exceeds that threshold, kicking off the cutting process. The elements depicted in FIG. 10 may also be interchangeable with other elements of FIGS. 1-9 and 11-12 as required to realize a particularly desired embodiment.

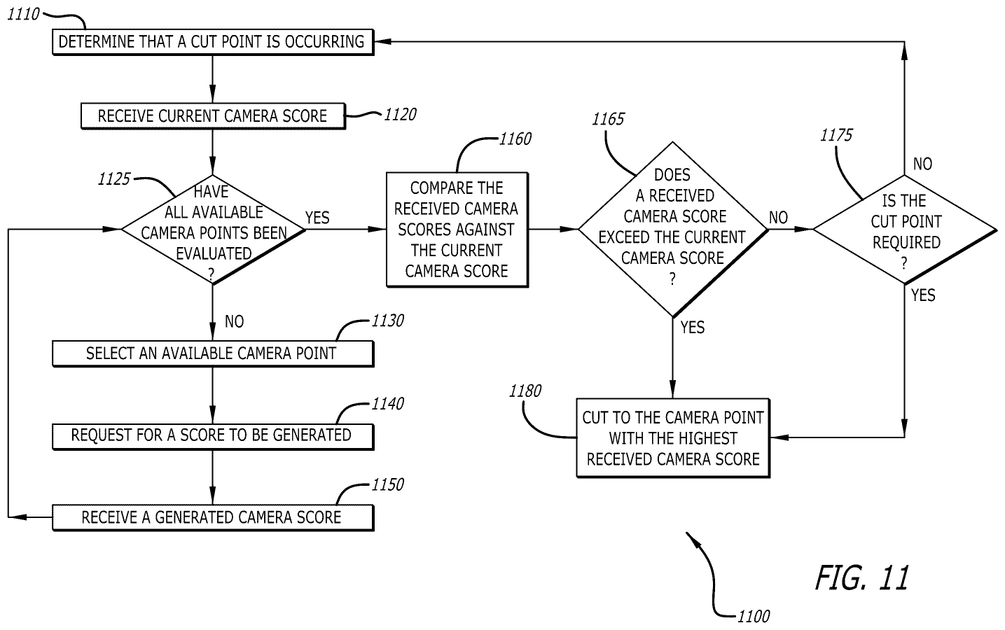

Referring to FIG. 11, a flowchart of a process 1100 for evaluating generated camera scores in accordance with various embodiments of the disclosure is shown. In many embodiments, the process 1100 can determine that a cut point is occurring (block 1110). Various events and scenarios can lead to a “cut point,” where the camera is configured to automatically transition to a different location or angle to enhance the player's experience. For example, when the player enters a new area or gaming environment, a cut point may occur to provide an optimal overview of the new surroundings, helping the player orient themselves quickly. Significant gameplay moments, such as boss fights, major plot reveals, or important character interactions, might trigger camera cuts to emphasize the event's significance and enhance the narrative impact. During fast-paced action scenes like combat or chase sequences, frequent camera cuts can maintain a dynamic and engaging perspective, ensuring the player has a clear view of the action and any threats.

When engaging with puzzles or interacting with objects, the camera can cut to a focused view that highlights the relevant elements, aiding in solving the puzzle or understanding the interaction. If the player's position relative to the environment changes drastically, such as climbing to a higher vantage point or descending into a lower area, a cut point can adjust the camera to maintain an optimal viewing angle. During cutscenes or extended dialogue sequences, the camera may cut to pre-determined angles that best showcase the characters and their expressions, enhancing the storytelling aspect of the game. Additionally, if the player's view becomes obstructed by environmental elements like walls, trees, or large objects, a cut point can shift the camera to a better angle, ensuring the player maintains clear visibility.

In a number of embodiments, the process 1100 can receive a current camera score (block 1120). The current camera score can represent a real-time evaluation of how effectively the active camera setup adheres to one or more scoring schemes. This current score can consider several factors as discussed above, including framing quality, clarity of the action, smoothness of movement, and overall contribution to immersion and gameplay. As the game progresses, the current camera score can fluctuate, responding to new changes within the scene. In some embodiments, the score is constantly updated and available upon request. In certain embodiments, the current camera score is not requested or otherwise accessed until a direct comparison is done elsewhere within the process 1100.

In more embodiments, the process 1100 can determine if all available camera points have been evaluated (block 1125). As previously discussed, a given game environment may be populated with a plurality of camera points that can host a virtual camera. If a cut is to occur, some or all of these available camera points within the scene or environment can be evaluated for a potential cut point.

If it is determined that the not all available camera points have been evaluated, then the process 1100 can select an available camera point (block 1130). In a given scene, any number of camera points may be available. As discussed previously, each scene or gaming environment may have a number of pre-selected or established camera points. In certain embodiments, the process 1100 may be able to generate dynamic or unique camera points in relation to the current game state.

In additional embodiments, the process 1100 can request for a score to be generated (block 1140). In some embodiments, the available camera points may have scores dynamically evaluated for each available camera point. However, in certain embodiments, the camera points may not generate a score until one is requested. This request can be done via a function call or other similar process. The request may also be transmitted directly to each camera point or broadcast to a number of camera points.

In further embodiments, the process 1100 can receive a generated camera score (block 1150). In response to a request for a camera score, the process 1100 can receive a score for each of the available or requested camera points at once or individually with the scores being stored in an intermediate value or other container. In some embodiments, the score can be received via a return value from a function call. In certain embodiments, the received camera scores may only be stored as a single value associated with the camera point with the highest score, until another generated camera score is received that is higher, thus “knocking” the old score from the current storage.

However, if the process 1100 determines that all camera points have been evaluated, then various embodiments can compare the received camera scores against the current camera score (block 1160). As previously discussed, the comparison can be done on a one-to-one basis, or may be done by sorting a list of values or tables such that a highest score is available or otherwise accessible. Once known, this highest generated score can be compared against the current camera score, which should preferably be formatted within the same scale or grade as the generated camera scores.

In still more embodiments, the process 1100 can determine if a received camera score exceeds the current camera score (block 1165). This determination can be a simple evaluation of the address or data structure associated with the highest camera score. In some embodiments, the evaluation may require that the generated camera score not simply exceed the current camera score, but also a current camera score plus buffer value or a unique predetermined threshold. The choice of determination can be done in response to certain conditions or game states as desired by the developers.

If it is determined that a received camera score does exceed the current camera score, the process 1100 can cut to the camera point with the highest received camera score (block 1180). Ultimately, the cut point may be configured to generate a cut to a better camera within the game environment, which can be determined by the camera point with the highest received or generated camera score. As discussed above, the cut may be to the camera that has the highest score that also satisfies one other condition that is set as a restriction within the cut point (e.g., don't cut to the close-up camera, etc.). In some embodiments, this restriction can be indicated by adjusting the weight of one or more characteristics of the camera point. In additional embodiments, that restriction can simply be an indicator that a specific camera point should not be picked during the evaluation process.

However, if it is determined that the received camera scores do not exceed the current camera score, then the process 1100 may, in certain embodiments, further determine if the cut point is required (block 1175). In various embodiments, the potential cut point may occur but end up determining that the current camera is the best suited for rendering still. However, various situations or game states may occur where a cut point is required away from the current camera. For example, a camera point may have an enemy or other character occluding the camera view of the player. While the evaluation process may deem this camera to be insufficient via weight changes in the scoring process, the developers may want to make certain heuristics or other conditions that require that a cut occur away in certain situations. This may also be desired in some embodiments during a transition to or from a cut scene.

If it is determined that the cut point is required, then the process 1100 can, in various embodiments, cut to the camera point with the highest received camera score (block 1180). In these cases, the process 1100 may simply select the camera point with the second highest score to cut to. However, if it is determined that the cut point is not required, then the process 1100 may again continue operating until it is determined that another cut point is occurring (block 1110). This may lead in certain circumstances to keep a static camera shot active, even during multiple cut points.

In certain embodiments, to prevent rapid, oscillating cuts between two similarly-scored camera points, the full control camera logic may be configured to require that a new camera score exceed the current camera score by a predetermined buffer value or percentage. This introduces a hysteresis effect, ensuring that a camera cut only occurs when a demonstrably superior view is available. This enhances visual stability and prevents a “camera fighting” effect that could be jarring to the player. Furthermore, a player may provide a “hint” via a controller input, which can act as a trigger for a required cut point, effectively allowing the player to override a camera angle they find unsuitable.

The evaluation of available camera points may be performed sequentially or in parallel. In some embodiments, upon determining a cut point, the system can broadcast a single request to all available camera points simultaneously, allowing them to generate their scores concurrently. This parallel processing approach can reduce the latency between the trigger event and the execution of the camera cut, resulting in a more responsive system, particularly in scenes with a high density of potential camera points.

In additional embodiments, the camera scoring process may be predictive. The full control camera logic can be configured to analyze player movement data, such as velocity and trajectory, to predict the player character's future position within the game environment. The camera scores for available camera points can then be generated based on how effectively each camera would frame this predicted future position. This allows the system to proactively cut to an optimal camera angle just before a key moment occurs, making the cinematography feel more intentional and less reactive to past events.

Referring to the process 1100 of FIG. 11, in some embodiments, the full control camera logic determines that a cut point is occurring (block 1110) and then requests that scores be generated for the available camera points (block 1140). In certain embodiments, this evaluation can be influenced by historical and player-specific data. For instance, the logic may incorporate historical telemetry data to weigh certain camera angles more favorably. In other embodiments, the evaluation may be responsive to player feedback, such as a controller hint or learned preferences. In yet another embodiment, after cutting to the camera point with the highest received score (block 1180), the logic may also establish a time-based buffer. During a subsequent evaluation, the system will check if this buffer's predetermined time has elapsed before executing a new cut (block 1175), preventing excessively rapid camera changes and creating a smoother visual experience for the player.

Although a specific embodiment for a flowchart of a process for evaluating generated camera scores suitable for carrying out the various steps, processes, methods, and operations described herein is discussed with respect to FIG. 11, any of a variety of systems and/or processes may be utilized in accordance with embodiments of the disclosure. For example, the specific steps shown for the evaluation may vary depending on the application desired. If the cut point is triggered by the current camera falling below a particular score, the process 1100 may be triggered, but then cancelled if the current camera score again exceeds a particular cut point threshold. The elements depicted in FIG. 11 may also be interchangeable with other elements of FIGS. 1-10 and 12 as required to realize a particularly desired embodiment.

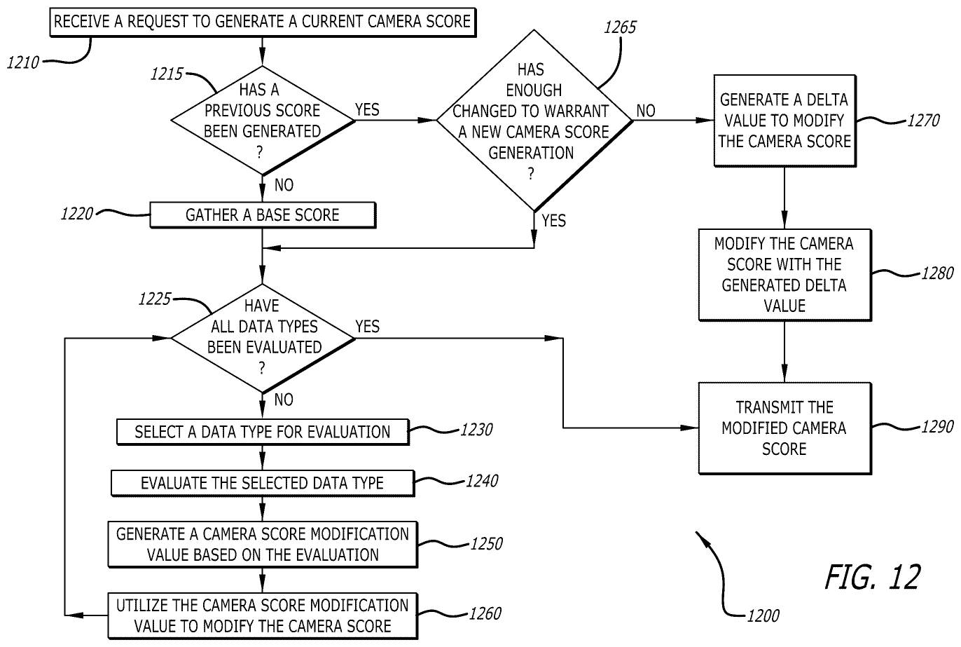

Referring to FIG. 12, a flowchart of a process 1200 for generating a camera score in accordance with various embodiments of the disclosure is shown. In many embodiments, the process 1200 can receive a request to generate a current camera score (block 1210). In certain embodiments, the camera points or cameras associated with the process 1200 can continuously generate scores as changes in game states occur. However, in some embodiments, the generation of a score may only occur in response to a received request.

In a number of embodiments, the process 1200 can determine if a previous score has been generated (block 1215). As previously discussed, a camera point or camera within a game environment may generate a score multiple times. In some cases, if a score was just generated, a full re-calculating of the score may not be needed. However, as different scenes and game environments are generated and/or released within a game session, different camera points may not have been evaluated subsequently to instantiation.

If it is determined that a previous score has not been generated, then various embodiments of the process can gather a base score (block 1220). In various embodiments, each camera point may have an associated base score value that can weigh the overall score. In some embodiments, such as the embodiment depicted in FIG. 12, the base score is gathered and simply modified in response to other data type evaluations.

In more embodiments, the process 1200 can further determine if all data types have been evaluated (block 1225). Data types can refer to any heuristic or output from one or more machine-learning processes that can be derived from or otherwise associated with different camera characteristics, photographic, and/or cinematography principles. For example, some embodiments of the process 1200 may assess framing quality, ensuring that key elements such as the player character, NPCs, and significant objects are well-positioned and visible according to cinematic principles like the rule of thirds, balance, and the like. Other data types, such as, for example, movement data can be analyzed to determine the smoothness and fluidity of the camera transitions, avoiding abrupt or jarring changes that could disrupt the player's immersion. By integrating these evaluations, embodiments of the process 1200 can generate a comprehensive score that reflects the potential camera's effectiveness as a cutting point target.

If it is determined that all data types have not been evaluated, then some embodiments of the process 1200 can select a data type for evaluation (block 1230). As discussed above, data types for evaluation can involve different types of data or sub-data associated with the game state, camera point, virtual camera, gaming environment, or other relevant aspect. In some embodiments, only certain data types are selected based on recent changes in the game state, or in response to one or more limitations placed on the score generation request.

In additional embodiments, the process 1200 can evaluate the selected data type (block 1240). The evaluation can be done based on the data type being evaluated. As those skilled in the art will recognize, each data type can require a unique evaluation to generate a relative score for the camera point. For example, evaluations on framing may require the generation or pseudo-generation of a virtual camera to render the scene or determine what elements in the game scene would be captured or otherwise rendered by the camera were it to be cut to. In contrast, when evaluating a cinematography principle, such as focal length, the evaluation may be limited based on a restriction or property set for that particular camera point, etc. (e.g., a “drone” camera for example, may not be equipped with a high-quality cinema lens to mimic real-life limitations, etc.)

In further embodiments, the process 1200 can generate a camera score modification value based on the evaluation (block 1250). Based on the different types of evaluations done, the results may need to be scaled or otherwise converted to comport with the current score being generated/evaluated/modified. For example, how a subject fits in a frame responsive to the “rule of thirds” principle may be a binary evaluation, or may be linear or exponentially scored based on a subject's proximity to a proper intersection point. In some embodiments, this score generation may also be formatted sufficiently based on the weight applied to the data type. In additional embodiments, a generated initial or raw score may be scaled with a multiplier or otherwise cross-referenced within a conversion table prior to being used by the process 1200 for score generation.

In still more embodiments, the process 1200 can utilize the camera score modification value to modify the camera score (block 1260). As previously discussed, various embodiments may have an initial base score, and each subsequent data type evaluated can modify that value either closer or farther away from an ideal camera score. However, in certain embodiments, the score may just be summed from each derived data type value, both positive and/or negative.

If it is now determined that all data types have been evaluated, then the process 1200 can transmit the modified camera score (block 1290). Once all data types have been utilized to modify the camera score, the process 1200 can take that final value and send it back to the requesting element. In some instances, this transmission can be done via a return value to a function call. In numerous embodiments, the transmission can be to store the value in a storage space addressable by the requesting element. However, those skilled in the art will recognize that there are various ways to properly pass a value from one process 1200 to another.

In yet further embodiments, if it is determined that a previous score has been generated, then the process 1200 can additionally determine if enough change has occurred to warrant a new camera score generation (block 1265). Again, in certain instances, a full reevaluation of the camera score may not be needed. In these cases, some embodiments may only require the generation of a delta value to offset the previously generated score. In these embodiments, the delta can be generated by evaluating only the aspects that have changed since the last camera score generation.

If it is determined that enough change has occurred, then the process 1200 can in various embodiments, evaluate the available data types (block 1225). In certain embodiments, the process 1200 may instead gather a new base score prior to evaluating the data types. The determination of change may be directly related to the elapsing of time or a fixed value such as the number of game state changes, data values changes, scene environment changes, etc. This determination may, in some embodiments, be referencing a flag that can be tripped upon one or more events.

However, if it is determined that not enough change has occurred since the previous score was generated, then the process 1200 can, in some embodiments, generate a delta value to modify the camera score (block 1270). In various embodiments, the delta value can be generated by evaluating only a subset of the data types. In some embodiments, the delta value can be estimated based on the camera's proximity to another previously evaluated camera. This may be beneficial for dynamically moving cameras that may not change much from one position to the next along a movement path.

In still additional embodiments, the process 1200 can modify the camera score with the generated delta value (block 1280). Similar to above, the modification of the camera score can be done via a series of evaluations that can modify that previous camera score either closer or farther away from an ideal camera score. However, in certain embodiments, the score may just be summed from each derived data type value, both positive and/or negative. Finally, in numerous embodiments, the process 1200 can transmit the modified camera score (block 1290).

FIG. 12 illustrates a method 1200 for providing a current camera score. In some embodiments, the method is initiated upon receiving a request (block 1210). The process can begin by gathering an initial base score for a camera point (block 1220). Subsequently, in certain embodiments, the logic evaluates a plurality of data types (block 1225), such as framing, player visibility, and adherence to cinematic principles. For each data type evaluated (block 1240), a modification value is generated (block 1250) and used to modify the camera score (block 1260). After all relevant data types have been processed, the final, modified camera score is transmitted (block 1290) for use in the cut determination processes of FIGS. 10 and 11.

In further embodiments, the process 1200 includes an optimization for efficiency. Before gathering a new base score, the logic can determine if a previous score has already been generated for that camera point (block 1215). If so, it further evaluates if a sufficient change in the game state has occurred to warrant a full recalculation (block 1265). In some embodiments, if not enough has changed, instead of performing a full evaluation, the system can generate a smaller delta value (block 1270) that reflects the minor changes. This delta value is then used to modify the previously generated camera score (block 1280), and this updated score is transmitted. This approach reduces computational load by avoiding unnecessary recalculations, allowing the system to maintain high performance while still providing accurate, up-to-date camera scores.

Although a specific embodiment for a flowchart of a process for generating a camera score suitable for carrying out the various steps, processes, methods, and operations described herein is discussed with respect to FIG. 12, any of a variety of systems and/or processes may be utilized in accordance with embodiments of the disclosure. For example, the process 1200 may be incorporated into one or more logics such that elements of the process 1200 are interchangeable with other processes, such as those depicted in the embodiments shown in FIGS. 10 and 11. The elements depicted in FIG. 12 may also be interchangeable with other elements of FIGS. 1-11 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a full control camera logic, stored in the memory and executed by the processor, configured to:
establish an environment with a plurality of camera points;
render a camera at one of the plurality of camera points;
determine that a potential cut point has occurred;
evaluate the plurality of camera points wherein each camera point is associated with a current camera score; and
cut to the camera point with the highest current camera score.

2. The device of claim 1, wherein the plurality of camera points are associated with a video game environment.

3. The device of claim 2, wherein the video game environment is rendered in real-time or near real-time.

4. The device of claim 1, wherein the cut point occurs in response to entering a new area.

5. The device of claim 1, wherein the rendered camera has a camera score generated continuously.

6. The device of claim 5, wherein the cut point occurs when the rendered camera score falls below a predetermined threshold.

7. The device of claim 1, wherein the cut point occurs in response to a dialogue sequence initiating.

8. The device of claim 1, wherein the evaluation of the current camera score is based on at least historical data.

9. The device of claim 1, wherein the evaluation of the current camera score is based on at least player feedback.

10. The device of claim 1, wherein the full control camera logic is further configured to establish a buffer with a predetermined time after cutting to the camera point with the highest camera score.

11. The device of claim 10, wherein the full control camera logic is further configured to determine, in response to evaluating the plurality of camera points, if the predetermined time within the buffer has elapsed.

12. The device of claim 11, wherein cutting to the camera point with the highest current camera score occurs only if the predetermined time within the buffer has elapsed.

13. A method of cutting a camera within a virtual environment, the method comprising:
establishing an environment with a plurality of camera points;
rendering a camera at one of the plurality of camera points;
determining that a potential cut point has occurred;
evaluating the plurality of camera points wherein each camera point is associated with a current camera score; and
cutting to the camera point with the highest current camera score.

14. The method of claim 13, wherein the virtual environment is a video game environment.

15. The method of claim 14, wherein the video game environment is rendered in real-time or near real-time.

16. The method of claim 13, wherein the evaluation of the plurality of camera points is done continuously.

17. The method of claim 16, wherein the potential cut point is associated with a predetermined threshold score.

18. The method of claim 17, wherein the cutting is done automatically in response to the current camera score associated with the rendered camera falls below the predetermined threshold score.

19. A method of providing a current camera score, the method comprising:
receiving a request to generate a current camera score;
gathering a base score;
evaluate a plurality of data types;
modify the camera score based on each of the plurality of data types; and
transmit the modified camera score.

20. The method of claim 19, wherein the method further comprises:
determining, prior to gathering a base score, if there is a previously generated camera score;
evaluating, if there is a previously generated camera score, if a sufficient change has occurred to warrant the generation of a new camera score;
generating, in response to determining that a sufficient change has not occurred, a delta value;
modifying the previously generated camera score with the delta value;
transmitting the modified previously generated camera score.
